(19) United States
(12) Patent Application Publication
(10) Pub. No.: US 2019/0313642 A1
(43) Pub. Date: Oct. 17, 2019

(54) A SIMULTANEOUSLY ANTIMICROBIAL AND PROTEIN-REPELLENT POLYZWITTERION

(71) Applicant: ALBERT-LUDWIGS-UNIVERSITÄT FREIBURG, Freiburg Baden-Württemberg (DE)

(72) Inventors: Karen LIENKAMP, Gundelfingen (DE); Monika KUROWSKA, Wolfach (DE); Diana Lorena GUEVARA-SOLARTE, Freiburg (DE); Alice HETTLER, Freiburg (DE); Ali ALAHMAD, Freiburg (DE); Esther RIGA, Freiburg (DE)

(21) Appl. No.: 16/349,710

(22) PCT Filed: Nov. 14, 2017
(86) PCT No.: PCT/EP2017/079205

§ 371 Date: May 14, 2019

(30) Foreign Application Priority Data
Nov. 15, 2016 (DE) 10 2016 222 407.7

(51) Int. Cl. A01N 43/08; A01N 43/32; A01N 37/18; A01N 37/10

(52) U.S. Cl. CPC A01N 43/08; A01N 37/10; A01N 37/18; A01N 43/32

(57) ABSTRACT

The present invention concerns a simultaneously antimicrobial and antifouling and protein repellent polyzwitterion (monolayers, polymer networks and surface-attached polymer networks formed thereby), and substrates coated with the inventive simultaneously antimicrobial and antifouling and protein repellent polyzwitterion. The invention also concerns uses of the inventive polymers and substrates for preventing and combating microbial growth.

The present invention concerns a simultaneously antimicrobial and antifouling and protein repellent polyzwitterion (monolayers, polymer networks and surface-attached polymer networks formed thereby), and substrates coated with the inventive simultaneously antimicrobial and antifouling and protein repellent polyzwitterion. The invention also concerns uses of the inventive polymers and substrates for preventing and combating microbial growth.

Bacterial biofilms that grow on medical products, for example on catheters, cause severe infections that cost the lives of more than hundred thousand people every year worldwide. In addition, the growing resistance of bacteria against antibiotics, e.g. among E. coli, S. aureus (MRSA), K. pneumoniae and E. faecalis, has turned this problem into a serious menace to patients in modern healthcare settings. According to the world health organization ‘antibiotic resistance is no longer a prediction for the future; it is happening right now, across the world, and is putting at risk the ability to treat common infections in the community and hospitals. Without urgent, coordinated action, the world is heading towards a post-antibiotic era, in which common infections and minor injuries, which have been treatable for decades, can once again kill’ (World Health Organization (WHO), Report on global surveillance of antimicrobial resistance, 2014, http://www.who.int/mediacentre/factsheets/fs194/en/). Therefore, simple yet efficient medical coatings that are able to reduce bacterial infections and biofilm formation are urgently needed.

The first step in biofilm formation is the adhesion of proteins to a surface; these form a conditioning layer, onto which bacteria can settle down reversibly. By secreting adhesins (sticky proteins), the initially reversible bacterial adhesion becomes soon irreversible. Bacteria then form colonies and eventually a joint extracellular matrix with other pathogens, (e.g. fungi like Candida albicans). Inside the biofilm, they are well protected against antibiotics and the bodies' own immune system. Eventually, this biofilm ruptures and releases planktonic bacteria into the organism, which spreads the infection further and may eventually kill the patient. Studies showed that antibiotics concentrations need to be increased by a factor of up to 1000 to kill bacteria in a biofilm, which is often toxic to humans. This is what makes biofilms so dangerous.

In past years, scientists have spent tremendous efforts to obtain materials that slow down biofilm formation, especially by using “anti-fouling” and antimicrobial coatings that interfere with the processes occurring in the early stages of biofilm formation. Coatings that impair adhesion of proteins and bacteria fall into two classes. So-called “fouling-release” coatings like poly(dimethyl siloxane) (PDMS) and PDMS-based micro- and nanostructured surfaces have a low mechanical moduli; proteins and bacteria may adhere on them due to their hydrophobicity, but can be easily sheared off, e.g. by flow. On the other hand, “non-fouling” polymers have such a low interfacial energy that the adhesion energy gained by adhering proteins or is not sufficient to make it irreversible. Poly(ethylene glycol) (PEG), which is the gold standard in the field, has shown promising properties for short term applications in vitro, but unfortunately can undergo oxidative degradation and chain cleavage. Therefore, other “non-fouling” coatings, in particular strongly swelling, hydrophilic polymers like poly(dimethyl acrylamide) have been developed. Polyzwitterions and polyzwitterion-based coatings were also deemed to be very interesting non-fouling coatings because they mimic the zwitterionic nature of the envelope of mammalian cells, which also consists of zwitterionic phospholipids. While these approaches are often very useful against protein and bacterial adhesion, their weak point is that they are often vulnerable to lipid fouling. Bacteria can then settle on that conditioning layer of lipids and initiate biofilm formation. This led to the development of materials that combined fouling-release and non-fouling materials, where one polymer component would be protein-repellent, but not lipid-repellent, and vice versa. Yet the drawback of all materials that rely on fouling-release or non-fouling is that, once even single bacteria manage to settle (e.g. on debris, adhered lipids, or surface defects), these can form a biofilm in less than 24 hours. Coatings with antimicrobial components, on the other hand, kill bacteria or slow down their proliferation rate. In “leaching antimicrobial coatings”, the active agents (e.g. antibiotics, heavy metals silver, or other biocides) are embedded into a polymer matrix and gradually leak out. Such materials have been successfully applied in vitro; however there is still no satisfactory proof-of-principle on the clinical level. Additionally, they lose activity when their active component reaches sublethal concentrations, which may cause bacterial resistance in the patient or downstream in hospital waste water and eventually the environment. In an alternative approach, non-leaching, intrinsically antimicrobial coatings made from cationic polymers were developed. These polycationic surface-attached coatings electrostatically attract bacteria, which have negatively charged cell envelopes, and kill damage their membranes by a local, physical effect caused primarily by the polymers' charges and hydrophobic components. In this regard, polycationic “Synthetic Mimics of Antimicrobial Peptides” (SMAMPs) were shown to imitate the activity of the body's own antimicrobial peptides and exhibit excellent antimicrobial activity and low toxicity to human cells, and are thus promising candidates for medical applications. The weak spot of antimicrobial polycation surfaces is that, besides attracting bacteria, they also collect the negatively charged debris of the killed bacteria, which means that they are exhausted once they are fully covered by debris.

Since both “anti-fouling” and antimicrobial surfaces have only one line of defense against bacteria, researchers tried to combine these approaches by making bifunctional materials containing anti-adhesive and antimicrobially active components. However, most of these materials either had limited dual anti-adhesive and antimicrobial activity, or were so complicated to make that they are only of academic interest. Thus, in the light of the above described medical scenario, a simple coating with dual antimicrobial and protein-repellent activity would be highly attractive and remains to be developed.

This problem has been solved according to the present invention by a material based on a carboxybetain-based polyzwitterion (PZI), which is, to the best knowledge of the instant inventors, the first report of a simultaneously antimicrobial and protein-repellent polymer consisting of just one active component. The instant invention thereby presents an easy way to immobilize this polymer as a network on both laboratory and real life surfaces. This application also demonstrates that this PZI was even more strongly antibacterial than a potent antimicrobial SMAMP polymer, at the same time significantly reduces biofilm formation, and has a low toxicity to human keratinocytes. It is thus an extremely attractive coating to fight bacterial biofilms on medical devices. The instant invention furthermore shows an attempt to rationalize these amazing biological properties by comparing the bioactivities of the PZI, the reference SMAMP, and a non-antimicrobial polyzwitterion with their physical properties.

In the context of the present invention, the term “anti-fouling” preferably refers to materials that resist fouling, i.e. adhesion of unwanted debris of mostly biological origin to the surface. This also includes protein-repellent, bacteria-repellent or marine organism-repelling properties.

According to a first embodiment, the problem underlying the present invention is solved by a simultaneously antimicrobial and antifouling (protein repellent) polyzwitterion (PZI), in brief an antimicrobial and antifouling polymer as defined throughout the description and the attached claims, comprising a molecular weight of more than 5,000 g mol⁻¹, preferably more than 10,000 g mol⁻¹, and as a repeat unit a structure according to formula (I):

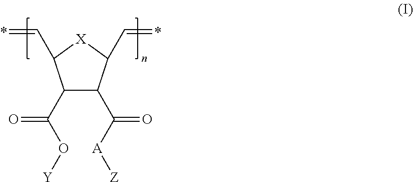

wherein
X is selected independently from each other from O, CR¹R², or C═CR¹R², wherein:
R¹ and R² are independently from each other selected from hydrogen (H), linear or branched C₁-C₆ alkyl, preferably hydrogen (H), methyl-, ethyl-, n-propyl-, isopropyl-, n-butyl, sec-butyl, tert-butyl, isobutyl, n-pentyl, iso-pentyl, neopentyl, sec-pentyl, tert-pentyl, or hexyl, more preferably hydrogen (H), or linear C₁-C₆ alkyl, even more preferably hydrogen (H), methyl-, ethyl-, n-propyl-, n-butyl, n-pentyl, or hexyl,
   Y is selected from hydrogen or is a negative charge, preferably a negative charge;

### A is O or NH or NR;

Z is either (CH₂)_{q}N⁺(R³R⁴R⁵), wherein:
R³, R⁴, R⁵ are independently from each other selected from either H or an C₁-C₆-alkyl, preferably H, methyl-, ethyl-, propyl-, or isopropyl-, more preferably H;
q is an integer selected from a range of 1 to 10, preferably 2 to 10, more preferably 2 to 9, even more preferably 2 to 8 or 2 to 7 or 2 to 6;
or Z is (CH₂)_{q} B, wherein:
q is an integer selected from a range of 1 to 10, preferably 2 to 10, more preferably 2 to 9, even more preferably 2 to 8 or 2 to 7 or 2 to 6; and
B is defined according to formula (II)

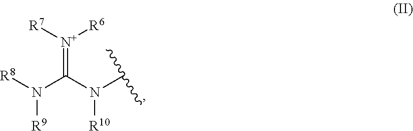

wherein
R⁶, R⁷, R⁸, R⁹ and R¹⁰ are independently from each other selected from either H or an C₁-C₆-alkyl, preferably H, methyl-, ethyl-, propyl-, or isopropyl-, more preferably H;
or Z is (CH₂)_{q}N(R¹¹R¹²), preferably if Y is selected from a hydrogen, wherein:
R¹¹, R¹² are independently from each other selected from either H or an C₁-C₆-alkyl, preferably H, methyl-, ethyl-, propyl-, or isopropyl-, more preferably H; and
q is an integer selected from a range of 1 to 10, preferably 2 to 10, more preferably 2 to 9, even more preferably 2 to 8 or 2 to 7 or 2 to 6; and
   n is an integer selected from a range of 10 to 2500.

According to a first aspect of the first embodiment, in formula (I) when X=O and A=O, then q=1 or q=3 to 10, Hence, q is then preferably not 2.

According to a second aspect of the first embodiment, in the repeat unit a structure according to formula (I) of the inventive antimicrobial and antifouling polymer

### X is O;

Y is selected from hydrogen or is a negative charge, preferably a negative charge;

### A is O;

Z is either (CH₂)_{q}N⁺(R³R⁴R⁵), wherein:
R³, R⁴, R⁵ are independently from each other selected from either H or an C₁-C₆-alkyl, preferably H, methyl-, ethyl-, propyl-, or isopropyl-, more preferably H;
q is an integer selected from a range of 1 to 10, preferably 2 to 10, more preferably 2 to 9, even more preferably 2 to 8 or 2 to 7 or 2 to 6; and most preferably 3 to 8 or 3 to 7 or 3 to 6;
or Z is (CH₂)_{q}N(R¹¹R¹²), preferably if Y is selected from a hydrogen, wherein:
R¹¹, R¹² are independently from each other selected from either H or an C₁-C₆-alkyl, preferably H, methyl-, ethyl-, propyl-, or isopropyl-, more preferably H;
q is an integer selected from a range of 1 to 10, preferably 2 to 10, more preferably 2 to 9, even more preferably 2 to 8 or 2 to 7 or 2 to 6; and
   n is an integer selected from a range of 10 to 2500.

According to a third aspect of the first embodiment, in the repeat unit a structure according to formula (I) of the inventive antimicrobial and antifouling polymer

X is CR¹R², wherein:
R¹ and R² are independently from each other selected from hydrogen (H), linear or branched C₁-C₆ alkyl, preferably hydrogen (H), methyl-, ethyl-, n-propyl-, isopropyl-, n-butyl, sec-butyl, tert-butyl, isobutyl, n-pentyl, iso-pentyl, neopentyl, sec-pentyl, tert-pentyl, or hexyl, more preferably hydrogen (H), or linear C₁-C₆ alkyl, even more preferably hydrogen (H), methyl-, ethyl-, n-propyl-, n-butyl, n-pentyl, or hexyl,
   Y is selected from hydrogen or is a negative charge, preferably a negative charge;

### A is O;

Z is (CH₂)_{q}N⁺(R³R⁴R⁵), wherein:
R³, R⁴, R⁵ are independently from each other selected from either H or an C₁-C₆-alkyl, preferably H, methyl-, ethyl-, propyl-, or isopropyl-, more preferably H;
q is an integer selected from a range of 1 to 10, preferably 2 to 10, more preferably 2 to 9, even more preferably 2 to 8 or 2 to 7 or 2 to 6;
or Z is (CH₂)_{q}N(R¹¹R¹²), preferably if Y is selected from a hydrogen, wherein:
R¹¹, R¹² are independently from each other selected from either H or an C₁-C₆-alkyl, preferably H, methyl-, ethyl-, propyl-, or isopropyl-, more preferably H;
q is an integer selected from a range of 1 to 10, preferably 2 to 10, more preferably 2 to 9, even more preferably 2 to 8 or 2 to 7 or 2 to 6; and
   n is an integer selected from a range of 10 to 2500.

According to a fourth aspect of the first embodiment, in the repeat unit a structure according to formula (I) of the inventive antimicrobial and antifouling polymer

X is CCR¹R², wherein:
R¹ and R² are independently from each other selected from hydrogen (H), linear or branched C₁-C₆ alkyl, preferably hydrogen (H), methyl-, ethyl-, n-propyl-, isopropyl-, n-butyl, sec-butyl, tert-butyl, isobutyl, n-pentyl, iso-pentyl, neopentyl, sec-pentyl, tert-pentyl, or hexyl, more preferably hydrogen (H), or linear C₁-C₆ alkyl, even more preferably hydrogen (H), methyl-, ethyl-, n-propyl-, n-butyl, n-pentyl, or hexyl,
   Y is selected from hydrogen or is a negative charge, preferably a negative charge;

### A is O;

Z is (CH₂)_{q}N⁺(R³R⁴R⁵), wherein:
R³, R⁴, R⁵ are independently from each other selected from either H or an C₁-C₆-alkyl, preferably H, methyl-, ethyl-, propyl-, or isopropyl-, more preferably H;
q is an integer selected from a range of 1 to 10, preferably 2 to 10, more preferably 2 to 9, even more preferably 2 to 8 or 2 to 7 or 2 to 6;
or Z is (CH₂)_{q}N(R¹¹R¹²), preferably if Y is selected from a hydrogen, wherein:
R¹¹, R¹² are independently from each other selected from either H or an C₁-C₆-alkyl, preferably H, methyl-, ethyl-, propyl-, or isopropyl-, more preferably H;
q is an integer selected from a range of 1 to 10, preferably 2 to 10, more preferably 2 to 9, even more preferably 2 to 8 or 2 to 7 or 2 to 6; and
   n is an integer selected from a range of 10 to 2500.

According to a fifth aspect of the first embodiment, in the repeat unit a structure according to formula (I) of the inventive antimicrobial and antifouling polymer

### X is O;

Y is selected from hydrogen or is a negative charge, preferably a negative charge;

### A is NH;

Z is (CH₂)_{q}N⁺(R³R⁴R⁵), wherein:
R³, R⁴, R⁵ are independently from each other selected from either H or an C₁-C₆-alkyl, preferably H, methyl-, ethyl-, propyl-, or isopropyl-, more preferably H;
q is an integer selected from a range of 1 to 10, preferably 2 to 10, more preferably 2 to 9, even more preferably 2 to 8 or 2 to 7 or 2 to 6;
or Z is (CH₂)_{q}N(R¹¹R¹²), preferably if Y is selected from a hydrogen, wherein:
R¹¹, R¹² are independently from each other selected from either H or an C₁-C₆-alkyl, preferably H, methyl-, ethyl-, propyl-, or isopropyl-, more preferably H;
q is an integer selected from a range of 1 to 10, preferably 2 to 10, more preferably 2 to 9, even more preferably 2 to 8 or 2 to 7 or 2 to 6; and
   n is an integer selected from a range of 10 to 2500.

According to a sixth aspect of the first embodiment, in the repeat unit a structure according to formula (I) of the inventive antimicrobial and antifouling polymer

X is CR¹R², wherein:
R¹ and R² are independently from each other selected from hydrogen (H), linear or branched C₁-C₆ alkyl, preferably hydrogen (H), methyl-, ethyl-, n-propyl-, isopropyl-, n-butyl, sec-butyl, tert-butyl, isobutyl, n-pentyl, iso-pentyl, neopentyl, sec-pentyl, tert-pentyl, or hexyl, more preferably hydrogen (H), or linear C₁-C₆ alkyl, even more preferably hydrogen (H), methyl-, ethyl-, n-propyl-, n-butyl, n-pentyl, or hexyl,
   Y is selected from hydrogen or is a negative charge, preferably a negative charge;

### A is NH;

Z is (CH₂)_{q}N⁺(R³R⁴R⁵), wherein:
R³, R⁴, R⁵ are independently from each other selected from either H or an C₁-C₆-alkyl, preferably H, methyl-, ethyl-, propyl-, or isopropyl-, more preferably H;
q is an integer selected from a range of 1 to 10, preferably 2 to 10, more preferably 2 to 9, even more preferably 2 to 8 or 2 to 7 or 2 to 6;
or Z is (CH₂)_{q}N(R¹¹R¹²), preferably if Y is selected from a hydrogen, wherein:
R¹¹, R¹² are independently from each other selected from either H or an C₁-C₆-alkyl, preferably H, methyl-, ethyl-, propyl-, or isopropyl-, more preferably H;
q is an integer selected from a range of 1 to 10, preferably 2 to 10, more preferably 2 to 9, even more preferably 2 to 8 or 2 to 7 or 2 to 6; and
   n is an integer selected from a range of 10 to 2500.

According to a seventh aspect of the first embodiment, in the repeat unit a structure according to formula (I) of the inventive antimicrobial and antifouling polymer

X is CCR¹R², wherein:
R¹ and R² are independently from each other selected from hydrogen (H), linear or branched C₁-C₆ alkyl, preferably hydrogen (H), methyl-, ethyl-, n-propyl-, isopropyl-, n-butyl, sec-butyl, tert-butyl, isobutyl, n-pentyl, iso-pentyl, neopentyl, sec-pentyl, tert-pentyl, or hexyl, more preferably hydrogen (H), or linear C₁-C₆ alkyl, even more preferably hydrogen (H), methyl-, ethyl-, n-propyl-, n-butyl, n-pentyl, or hexyl,
   Y is selected from hydrogen or is a negative charge, preferably a negative charge;

### A is NH;

Z is (CH₂)_{q}N⁺(R³R⁴R⁵), wherein:
R³, R⁴, R⁵ are independently from each other selected from either H or an C₁-C₆-alkyl, preferably H, methyl-, ethyl-, propyl-, or isopropyl-, more preferably H;
q is an integer selected from a range of 1 to 10, preferably 2 to 10, more preferably 2 to 9, even more preferably 2 to 8 or 2 to 7 or 2 to 6;
or Z is (CH₂)_{q}N(R¹¹R¹²), preferably if Y is selected from a hydrogen, wherein:
R¹¹, R¹² are independently from each other selected from either H or an C₁-C₆-alkyl, preferably H, methyl-, ethyl-, propyl-, or isopropyl-, more preferably H;
q is an integer selected from a range of 1 to 10, preferably 2 to 10, more preferably 2 to 9, even more preferably 2 to 8 or 2 to 7 or 2 to 6; and
   n is an integer selected from a range of 10 to 2500.

According to a particularly preferred eighth aspect of the first embodiment, the repeat unit with a structure according to formula (I) of the inventive antimicrobial and antifouling polymer is selected from any of formulae (Ia) to (Ie):

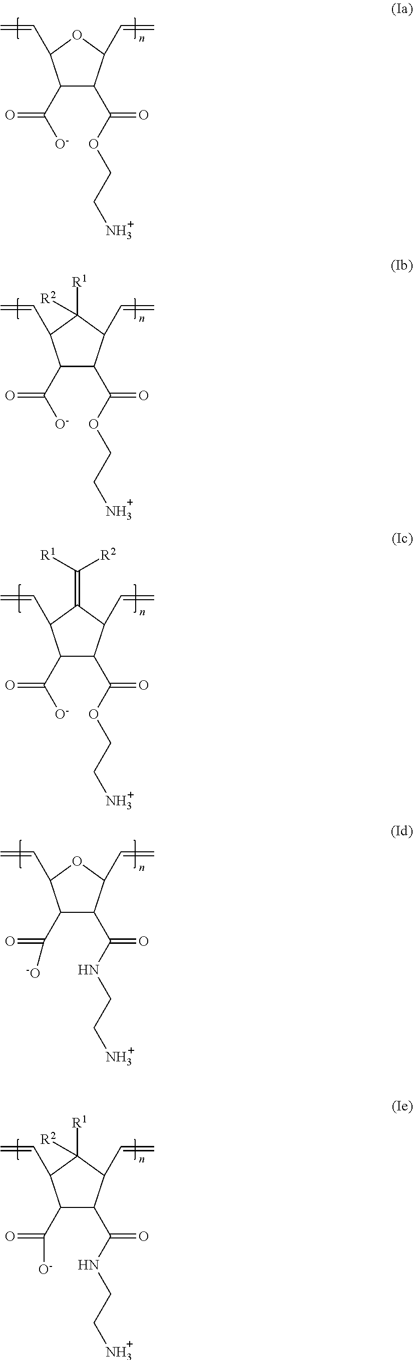

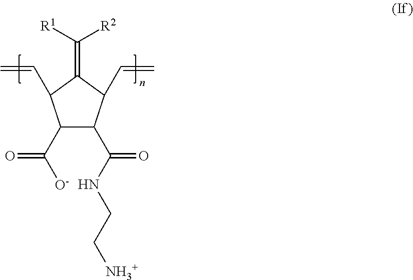

Likewise preferred, the repeat unit with a structure according to formula (I) of the inventive antimicrobial and antifouling polymer is selected from any of formulae (Ib) to (Ie), hence excluding antimicrobial and antifouling polymers with a repeat unit having the specific structure according to formula (Ia).

The antimicrobial and antibiofouling polymer according to the present invention and as depicted herein may comprise a molecular weight Mₙ of between 10,000 g mol⁻¹ and 1,000,000 g mol⁻¹, preferably between 10,000 g mol⁻¹ and 500,000 g mol⁻¹, more preferably between 20,000 g mol⁻¹ and 500,000 g mol⁻¹, and even more preferably between 20,000 g mol⁻¹ and 200,000 g mol⁻¹, between 20,000 g mol⁻¹ and 150,000 g mol⁻¹, or between 20,000 g mol⁻¹ and 100,000 g mol⁻¹, most preferably between 20,000 g mol⁻¹ and 95,000 g mol⁻¹.

In the context of this invention, the number average molecular weight Mₙ of the polymer is typically determined by gel permeation chromatography, which is calibrated with a polymer standard that is soluble in an appropriate solvent that also dissolves the inventive polymer, for example poly(methyl methacrylate) in chloroform, poly(ethylene oxide) in aqueous solution, poly(methylmethacrylate) in trifluoroethanol, etc. The same method is also used for modified polymers of the present invention, such as, e.g. the polymer with appropriate protective groups, and the like.

In the gel permeation chromatography measurements for determining the number average molecular weight Mₙ of the polymer of the present invention, typical GPC conditions are used, e.g. SDV columns or GRAM columns (available from Polymer Standard Services, Mainz, Germany) for chloroform; Suprema or Novema columns (available from Polymer Standard Services, Mainz, Germany) for aqueous solutions; Suprema or Novema columns (available from Polymer Standard Services, Mainz, Germany) for trifluoroethanol. Typical flow conditions are from 0.5 to 1 ml/min, wherein an appropriate salt may be optionally added to aqueous solvents and trifluoroethanol as needed.

Preferably, the inventive antimicrobial and antibiofouling polymer exhibits a significant growth reduction of bacterial pathogens, preferably on the surface, of at least about 7%, preferably at least about 70%, more preferably at least about 80%, even more preferably at least about 90%, likewise even more preferably at least about 95, 96, 97, 98, 99 or 99.99%, preferably of E. coli, P. aeruginosa, K. pneumoniae, S. aureus, S. epidermidis, and E. faecalis and other pathogens. In solution, this is preferably determined by a minimum inhibitory concentration assay as defined below. On surfaces, this is preferably determined by the spray assay defined below.

If the antimicrobial activity is to be determined on surfaces, preferably a spray assay is carried out as outlined in the attached examples (see also P. Zou, D. Laird, E. K. Riga, Z. Deng, F. Dorner, H.-R. Perez-Hernandez, D. L. Guevara-Solarte, T. Steinberg, A. Al-Ahmad, K. Lienkamp, Journal of Materials Chemistry B 2015, 3, 6224; JIS Z 2801:2000, or those described by Hadar et al. Nature Protocols 2007, 2(19), 2412; or by Al-Ahmad et al., PLoS One 2014, e111357).

The antifouling activity of the surface-attached polymer according to the present invention can be determined by standard procedures, e.g., those described by Jiang et al. (Quantification of the adhesion of fluorescently labeled proteins using fluorescence microscopy, after L. Mi, S. Jiang, Biomaterials 2012, 33, 8928-8933: Samples are immersed in 1 ml of 0.1 mg/ml FITC-labeled fibrinogen in PBS buffer at room temperature for 30 min to allow protein surface adsorption. After the protein incubation, samples are then rinsed gently with PBS buffer to remove any Fibrinogen that was only reversibly adhered to the surface. The surface fluorescence is then visualized using a Fluorescence Microscope through a FITC filter.) or Rühe et al. (Quantification of protein adhesion by surface plasmon resonance spectroscopy, after C. K. Pandiyarajan, O. Prucker, B. Zieger, J. Rühe, Macromol. Biosci. 2013, 13, 873-884: The adsorption of protein was evaluated by surface plasmon resonance spectroskopy. The dry thickness of the deposited surface-attached polymer network was measured, followed by the measurement of wet thickness in presence of buffer (PBS, 0.01M, pH 7.4, Sigma-Aldrich, Germany). Kinetic measurements were performed at an angle left of the minimum of the plasmon resonance curve. In a typical run, a peristaltic pump (Ismatec, Germany) was utilized to deliver the liquid samples to the SPR cell with a flow rate of 100 μL min⁻¹ (shear rate ca. 70 s⁻¹). The kinetic measurements were carried out in three stages. First, the PBS buffer was run through for 15 min to attain an equilibrium state (stable baseline). Second, fibrinogen in PBS (1 mg mL⁻¹) was flown in for 30 min and third, the PBS buffer was flown through for 15 min to remove non-adsorbed protein on the surface. During this process the change in the reflected intensity (R %) at the specified angle was recorded as a function of time. After completion of the kinetic measurement, the sample was dried and the dry thickness of organic layer was measured again, and the difference in the thickness before and after the experiment was taken as the adsorbed protein layer thickness.), or the like.

According to a second embodiment the present invention also concerns a polymer coating comprising the inventive antimicrobial and antifouling polymer. Preferentially, the coating is an (optionally surface-attached) polymer network, or a surface-attached polymer monolayer. Therein, the surface-attached monolayer is obtained by forming a (typically covalent) bond between the substrate and the inventive polymer using a “molecule for surface-attachment” as defined below. The polymer network is formed by “crosslinking” the antimicrobial and antifouling polymer using an “internal crosslinker” and/or an “external crosslinker” as defined below, so that (covalent) bonds between chains of the inventive polymer (and optionally also to the pre-treated substrate) are formed.

A “crosslinker” in the context of the present invention is any type of molecule that contains two or more “crosslinking units” as defined below, and can be used to form a (typically covalent) bond between two polymer chains or different chain segment of the same polymer chain, so that overall a polymer network is formed by combination of chemical crosslinking points (covalent bonds) and physical crosslinking points (chain entanglements) inside the polymer network.

A “crosslinking unit” is defined herein as a reactive moiety that can form a (typically covalent) bond to the inventive polymer. It is to be distinguished from other “reactive groups”, which are defined as reactive moieties that can form a (typically covalent) bond to other molecules, which are not the inventive polymer (e.g. “reactive groups” as defined herein may form bonds to a substrate).

A (small) molecule that carries at least one “reactive group”, and at least one “crosslinking unit” as defined above, and is able to connect to (the surface of) a substrate via at least one “reactive group”, and to the inventive polymer via at least one “crosslinking unit”, is defined as a “molecule for surface attachment”. The use of a “molecule for surface attachment” promotes adhesion and/or increases binding strength when attaching the inventive antimicrobial and antifouling polymer to a surface or substrate as described below.

A (small) molecule that carries at least two “crosslinking units”, and is not a “molecule for surface attachment”, and not part of the inventive polymer, is defined as an “external crosslinker”. “External crosslinkers” are used to form (covalent) bonds between two polymer chains or different chain segment of one polymer chain.

If the inventive polymer carries a “crosslinking unit” that is (covalently) attached to the inventive polymer, and is thus part of the inventive polymer, this is defined as an “internal crosslinker”. To be useful as an “internal crosslinker”, the inventive polymer needs to carry at least two “crosslinking units” per polymer chain. For example, to be useful as an “internal crosslinker”, a small fraction (0.05% to 10%) of the Z groups of the inventive polymer as defined in formula (I) are “crosslinking units” as defined below. Hence, for the purposes of the instant invention the Z group as defined above for formula (I) may be replaced by a crosslinking unit as defined herein. Such a repeat unit comprising as a Z group a crosslinking unit is then defined as a repeat unit according to formula (I′). For the purpose of the instant invention, such a repeat unit according to formula (I′) may then be contained in the inventive polymer together with the repeat unit according to formula (I) and is then preferably contained in the inventive polymer in a range of 0.05 to 10 wt % with regard to the entire polymer weight. Alternatively, polymers may be formed from the repeat unit according to formula (I) and further polymers may be formed having as a repeat unit according to formula (I′). Both polymers may then be mixed for the purpose of forming a polymer network and crosslinking polymers as defined herein, preferably 99.95 to 90 wt % polymers with a repeat unit according to formula (I) and 0.05 to 10 wt % of polymers with a repeat unit according to formula (I′), based on the entire weight of the polymers of the mixture.

A “crosslinking unit” can be part of either the “internal crosslinker”, the “external crosslinker” or the “molecule for surface attachment”, and may be selected preferably from a “photo-crosslinking unit” and/or a “thermo-crosslinking unit”.

Herein, the term “photo-crosslinking unit” refers to a reactive moiety that can be used to crosslink with the chains of the inventive antimicrobial and antifouling polymer as defined herein by activation through radiation (defined as “photo-activation” below).

A “photo-crosslinkable units” has preferably at least one latent “photo-activated group” that can become chemically reactive when exposed to an appropriate energy source, e.g. UV-radiation (UV-activation), visible light, microwaves, etc. As used herein, the phrase “photo-activated group” refers to a chemical moiety that is sufficiently stable to remain in an inactive state (i.e., the ground state) under normal storage conditions but that can undergo a transformation from the inactive state to an activated state when subjected to an appropriate external stimulus, in this case a radiative energy source. Upon exposure to that stimulus “photo-activated groups” generate reactive species, e.g. a radicals or biradicals, including, for example, a nitrene, carbene, excited states of ketone, or the like. This active species initiates the formation of a covalent bond to an adjacent chemical structure, e.g., as provided by the same or a different molecule.

The “photo-activation” of a “photo-crosslinking unit” as defined herein typically involves addition of an appropriate energy source as defined above, e.g. UV-radiation, visible light, microwaves, etc., preferably sufficient to allow covalent binding of the “photo-crosslinkable unit” to the inventive antimicrobial and antibiofouling polymer. Preferably, the inventive antimicrobial and antibiofouling polymer is bound via UV-radiation (UV-mediated crosslinking). More preferably, the integral light intensity at the sample location is typically about 0.50 to 10 J cm⁻², preferably about 0.500 to 5 J cm⁻², more preferably about 1 to 4 J cm⁻², e.g. about 3 J cm⁻². For UV-activation any suitable energy source may be applied known to a skilled person, e.g. a high-pressure mercury UV lamp, such as a high-pressure mercury UV lamp (e.g. 500 W, preferably from Oriel), or a StrataLinker 2400 (75 W, Stratagene). UV-activation may be about 2 to 300 min to give the desired energy density.

Suitable “photo-crosslinking units” are well-known to a person skilled in the art, e.g. from G. T. Hermanson, Bioconjugate Techniques, 3rd Edition, Academic Press, 2013, or V. V. Krongauz, A. D. Trifunac, Processes in Photo-reactive Polymers, Chapman & Hall, 1995; or Reiser/Arnost; Photo-reactive Polymers: The Science and Technology of Resists, Wiley Interscience, 1989. Preferably, a “photo-crosslinking unit” comprises a suitable “photo-reactive group”, e.g. a group comprising an aryl azide group (e.g. phenyl azides), an azide group, a diazo group, a diazirine group, a ketone group, a quinone group, an organic dye, or the like.

Preferably, the “photo-crosslinking unit” comprises an aryl ketone group, such as acetophenone, benzophenone, anthrone, and anthrone-like heterocycles (i.e., heterocyclic analogs of anthrone such as those having N, O, or S in the 10-position), or their substituted (e.g., ring substituted) derivatives. Examples of aryl ketones include heterocyclic derivatives of anthrone, including acridone, xanthone, and thioxanthone, and their ring substituted derivatives. Other suitable photo-crosslinkers comprise quinone such as, for example, anthraquinone. The functional groups of such aryl ketones can undergo multiple activation/inactivation/reactivation cycles. For example, benzophenone is capable of photochemical excitation with the initial formation of an excited singlet state that undergoes intersystem crossing to the triplet state. The excited triplet state can insert into carbon-hydrogen bonds by abstraction of a hydrogen atom (e.g., from a polymer, from a (pretreated) substrate and/or from a polymeric coating layer), thus creating a radical pair. Subsequent collapse of the radical pair leads to formation of a new carbon-carbon bond. If a reactive bond (e.g., carbon/hydrogen) is not available for bonding, the ultraviolet light-induced excitation of the benzophenone group is reversible and the molecule returns to ground state energy level upon removal of the energy source.

Alternatively, the “photo-crosslinking unit” may comprise a function selected from e.g. arylazide (C₆R⁵N₃) such as phenyl azide and 4-fluoro-3-nitrophenyl azide; acyl azide (—CO—N₃) such as benzoyl azide and p-methylbenzoyl azide; azidoformate (—O—CO—N₃) such as ethyl azidoformate and phenyl azidoformate; sulfonyl azide (—SO₂—N₃) such as benzenesulfonyl azide; and phosphoryl azide (RO)₂PON₃ such as diphenyl phosphoryl azide and diethyl phosphoryl azide. Diazo compounds constitute another class of photo-crosslinking units and include diazoalkanes (—CHN₂) such as diazomethane and diphenyldiazomethane; diazoketones (—C(═O)—CHN₂) such as diazoacetophenone and 1-trifluoromethyl-1-diazo-2-pentanone; diazoacetates (—O—C(═O)—CHN₂) such as t-butyl diazoacetate and phenyl diazoacetate; and beta-keto-alpha-diazoacetates (—C(═O)—CN₂—C(═O)—O—) such as t-butyl alpha diazoacetoacetate; etc. R may be preferably hydrogen or an alkyl as defined above.

Other “photo-crosslinking units” may include the diazirines (—CHN₂) such as 3-trifluoromethyl-3-phenyldiazirine; and ketenes (—CH—C(═O)—) such as ketene and diphenylketene.

According to one specific aspect of the approach using “photo-crosslinkable units”, each “photo-activated group” can abstract an atom, e.g. a hydrogen atom from an alkyl group, e.g. of the inventive polymer and/or the substrate. Thus, if the “photo-crosslinking unit” is part of a “molecule for surface attachment”, it typically forms a covalent bond between the substrate and the inventive polymer. If the “photo-crosslinking unit” is part of the “external crosslinker”, it typically forms a covalent bond between the “external crosslinker” and the inventive polymer. If the “photo-crosslinking unit” is part of the “internal crosslinker”, it typically forms a covalent bond to another part of the internal crosslinker, or to added chains of the inventive polymer that do not carry “photo-crosslinking units”.

Advantageously, the inventive antimicrobial and antifouling polymer can be crosslinked to form a polymer network by using either an “internal crosslinker” as defined above, or an “external crosslinker” as defined above. The “crosslinking units” are preferably “photo-crosslinking units” as defined above.

Alternatively or additionally to the above, the inventive antimicrobial and antifouling polymer may be attached to a material or substrate using “molecules for surface attachment”, as defined above. The “crosslinking units” on the “molecules for surface attachment” are preferably “photo-crosslinking units” as defined above.

Preferably, forming a network from the inventive antimicrobial and antifouling polymer, or connecting the inventive polymer to a (pretreated) surface, via a “photo-crosslinking unit” occurs via “photo-activation” as defined above.

The term “thermo-crosslinking unit” refers to a reactive moiety that can react with the chains of the inventive antimicrobial and antifouling polymer as defined herein by applying heat (defined as “thermo-activation”). “Thermo-activation” is defined as heating the sample in the range of from 40 to 200° C., more preferably in the range of from 60 to 120° C. In the context of the present invention, a “thermo-crosslinking unit” may be selected from any suitable compound forming covalent bonds to a substrate and/or the polymer of the invention upon subjecting the compound to heat treatment. Suitable thermo-crosslinking units are known in the art, e.g. from H. Dodiuk/S. Goodman, Handbook of Thermoset Plastics, 3rd Edition, 2013.

According to one specific aspect of the approach using “thermo-crosslinking units”, if the “thermo-crosslinking unit” is part of a “molecule for surface attachment”, it typically forms a covalent bond between the substrate and the inventive polymer. If the “thermo-crosslinking unit” is part of the “external crosslinker”, it typically forms a covalent bond between the “external crosslinker” and the inventive polymer. If the “thermo-crosslinking unit” is part of the “internal crosslinker”, it typically forms a covalent bond to another part of the internal crosslinker, or to added chains of the inventive polymer that do not carry “thermo-crosslinking units”.

Advantageously, the inventive antimicrobial and antifouling polymer can be crosslinked to form a polymer network by using either an “internal crosslinker” as defined above, or an “external crosslinker” as defined above. The “crosslinking units” are preferably “thermo-crosslinking units” as defined above.

Alternatively or additionally to the above, the inventive antimicrobial and antifouling polymer may be attached to a material or substrate using “molecules for surface attachment”, as defined above. The “crosslinking units” on the “molecules for surface attachment” are preferably “thermo-crosslinking units” as defined above.

Preferably, forming a network from the inventive antimicrobial and antifouling polymer, or connecting the inventive polymer to a (pretreated) surface, via a “thermo-crosslinking unit” occurs via thermo-activation as defined above.

Hence, in a preferred third embodiment, the antimicrobial and antifouling polymer of the invention is used to coat the surface of a material, substrate or product in a covalent or a non-covalent manner, preferably by covalently attaching the polymer to the surface thereof, i.e. by forming at least one covalent chemical bond between the polymer of the present invention and the material, substrate or product (i.e. the surface thereof). The present invention thereby also discloses a material, substrate or product accordingly coated, preferably by covalent attachment, with the inventive antimicrobial and antifouling polymer and/or with the polymeric network formed by the inventive antimicrobial and antifouling polymer, both as described herein.

Preferably, the polymer of the invention is covalently attached to such a surface of a material, substrate or product. Such a surface may be any suitable surface that carries appropriate functional groups or can be pre-treated so that it carries appropriate functional groups, preferably any surface that can be oxidized, thiolated or silanized, preferably an inorganic surface, such as e.g. surfaces containing or comprising metals or alloys, e.g. from iron, gold, silver, copper, aluminum, nickel, chrome, titanium, molybdenum, magnesium, zirconium, etc., or ceramics, titanium or zirconium oxides (TiO₂, etc.), etc., or an organic or polymeric surface, including thermosets, thermoplasts, elastomers, etc., and combinations thereof, such as oxidized poly(styrene) or oxidized poly(ethylene), (substituted) poly(ethyleneimine) (PEI), (substituted) poly(vinylpyridine) (PVP), (substituted) PVP-based polymers and co-polymers, poly(diallyldimethylammonium)-based, (substituted) poly(butylmethacrylate-co-aminoethyl methyl-acrylate), (substituted) poly(2-(dimethyl-amino)-ethyl methacrylate)-based surfaces, co-polymers thereof, or fluorinated polymers or co-polymers thereof, or silicone polymers or co-polymers thereof, including combinations thereof, or any further polymer suitable for such an approach, or silicon surfaces, such as e.g. SiO₂, glass etc. Such surfaces may be furthermore a surface of a substrate, e.g. of any implant, dental implant, prosthesis, joint, bone, tooth, e.g. of an artificial joint, artificial bone, artificial tooth, inlay, etc., as well as any material used or to be used for implanting such a substrate, e.g. screws, anchors, any fastener or fixing material, etc. as well as any material used or to be used for implanting such a substrate. Such substrates may furthermore be selected from any medical or surgical device or tool, including implant trephine or trepan drill, scalpels, forceps, scissors, screws, fasteners and/or fixing material used for implantation, holders, clips, clamps, needles, linings, tubes, water tubes, pipes, water pipes, bottles and bottle inlays, breathing hoses, inlays for medical equipment, etc., but also (surfaces of e.g.) operating tables, treatment chairs, catheter, stents, any wound dressing material, including plaster, gazes, bandages, but also bed sheets for clinical or medical purposes, sheets for covering medical devices, etc. Furthermore, surfaces or substrates may be selected from any further device, such as bindings or book covers, keyboards, computer keyboards, computer, laptops, displays, display covers, lamps, grips of tools and instruments, etc. Surfaces or substrates may also include any biomaterial suitable for tissue support, e.g. as a cell or tissue carrier system for wound dressing, or for volume preservation of solid body tissues. Surfaces or substrates may also include any substrate or surface used for storage of cells, tissue, organs, etc., but also any substrate or surface used for storage of food, such as refrigerators, coolers, storage boxes, etc.

For the purposes of the present invention, such a surface or (surface of a) substrate as defined herein may be pretreated to allow covalent binding of the antimicrobial and antifouling polymer of the invention. More preferably, the surface as defined above may be pretreated in two steps. In the optional first step (defined as Step I), functional groups are generated on the surface that allow binding of a “molecule for surface attachment”. In that case, the functional groups of the substrate would enable the “molecule for surface attachment” to attach to the surface through its “reactive group”. Optionally, after this pretreatment, the “molecule for surface attachment” as defined above is attached to the surface (defined as Step II). Preferably, Step I modifies the surface to comprise, e.g., oxide or hydroxide groups, thiol moieties, etc., depending on the nature of the “molecule for surface attachment”. Accordingly, the surface may be pre-treated prior to binding of the polymer of the invention to generate e.g. hydroxide or oxide groups, e.g. with a strong base such as sodium hydroxide, ammonium hydroxide, oxygen plasma, air plasma, UV, ozone, UV-ozone, heat, open flame, and the like, or with analogous methods to generate thiol groups. In the case of a metal, the metal can be subject to an oxidizing potential to generate oxide or hydroxide sites on the surface of the metal. In the case of an organic material, the organic material may be likewise pretreated to comprise e.g. oxide or hydroxide groups, etc. If the inorganic or organic material of the substrate already comprise the desired functional groups, or no covalent attachment to the polymer network using a “molecule for surface attachment” is intended, Step I can be omitted.

Preferably, in Step II, a “molecule for surface attachment” is reacted with the surface or (surface of a) substrate as defined herein. The “molecule for surface attachment” carries a “reactive group” as defined herein that can attach to said surface, and another moiety (“crosslinking unit”) that can attach to the inventive antimicrobial and antifouling polymer. It thus enables covalent binding between the oxide, thiol or other functional group on the surface, and the inventive antimicrobial and antifouling polymer. The “reactive group” may be, e.g. a reactive silane compound or a thiol/disulfide, or an epoxy-group, or the like. The “crosslinking unit” on the “molecule for surface attachment” may be a “thermo-crosslinking unit” and/or a “photo-crosslinking” as defined above.

As discussed above, the “molecule for surface attachment” is to be distinguished from the “internal crosslinker” and “external crosslinker” as defined above.

By the use of an “internal crosslinker” and/or an “external crosslinker” with “photo-crosslinking units” and/or “thermo-crosslinking units” in combination with “photo-activation” and/or thermo-activation”, a polymer network on the substrate is formed.

Alternatively, by the use of a “molecule for surface attachment” with “photo-crosslinking units” and/or “thermo-crosslinking units” in combination with “photo-activation” and/or thermo-activation”, a surface-attached monolayer on the substrate is formed.

Alternatively, by the use of a “molecule for surface attachment” (with “photo-crosslinking units” and/or “thermo-crosslinking units”), combined with the use of an “internal crosslinker” and/or an “external crosslinker” (with “photo-crosslinking units” and/or “thermo-crosslinking units”), combined with “photo-activation” and/or thermo-activation”, a surface-attached polymer network on the substrate is formed.

In this context, a suitable “molecule for surface attachment” carrying a “photo-crosslinking unit” as used in Step II, comprises, a “reactive group”. This “reactive group” may be, without being limited thereto, e.g. any silane, thiol or disulfide compound, preferably as mentioned herein. Additionally, the “molecule for surface attachment” carries at least one “photo-crosslinking unit” and allows formation of a covalent bond between said (pretreated) surface and the inventive polymer. For example, the “molecule for surface attachment” carrying a “photo-crosslinking unit” may comprise at least one “photo-crosslinking unit” as defined herein, and at least one “reactive group” of the group of silane compounds. Silane compounds are defined by having mono-, di-, or tri-alkoxyl silane moieties and/or mono-, di-, or tri-chlorosilane moieties, preferably silane compounds having at least one tri(C₁-C₃)alkoxysilyl group and/or at least one chlorosilane group. Suitable tri(C₁-C₃)alkoxysilyl groups include e.g. trimethoxysilyl, triethoxysilyl, and tripropoxysilyl, and combinations thereof. More preferably, the “molecule for surface attachment” carrying a “photo-crosslinking unit” may comprise, e.g., triethoxysilane-CH₂—CH₂—CH₂—O-benzophenone, (4-benzoylbenzoyl)amino(C₁-C₃)alkyltri(C₁-C₃)alkoxy silane, (4-benzoylbenzoyl)aminopropyltrimethoxy silane, (4-benzoylbenzoyl) aminoethyltrimethoxy silane, and 4-(3′-chlorodimethylsilyl)propyloxybenzophenone. Also suitable, especially if the surface is gold or silver, are the corresponding thiol, dithiol or disulfide compounds, for example the compound depicted in formula (III):

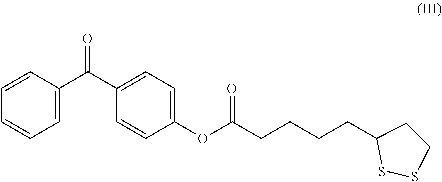 [SMILES: O=C(CCCCC1CCSS1)Oc1ccc(C(=O)c2ccccc2)cc1]

Binding of the “molecule for surface attachment” carrying a “photo-crosslinking unit” to the (pretreated) surface preferably occurs via its “reactive group”, e.g. the silane moiety if a silane compound is used, alternative via any further functionality, if a non-silane compound is used, e.g. hydroxyl moieties, —C(O)OH moieties, etc., or any further functional moiety of the “molecule for surface attachment” carrying a “photo-crosslinking unit” known to those skilled in the art that is suitable to bind to the optionally pretreated surface.

According to a further aspect, a suitable “molecule for surface attachment” carrying a “thermo-crosslinking unit” as used in Step II may comprise at least one “reactive group”. This “reactive group” may be, without being limited thereto, e.g. any silane, thiol or disulfide compound, preferably as mentioned herein. Additionally, the “molecule for surface attachment” carries at least one “thermo-crosslinking unit” as defined above and allows formation of a covalent bond between said (pretreated) surface with the “reactive group” and to the inventive polymer with the “thermo-crosslinking unit”. For example, the “molecule for surface attachment” carrying a “thermo-crosslinking unit” may comprise at least one “thermo-crosslinking unit” as defined herein, and at least one “reactive group” of the group of silane compounds. Silane compounds are defined by having mono-, di-, or tri-alkoxyl silane moieties and/or mono-, di-, or tri-chlorosilane moieties, preferably silane compounds having at least one tri(C₁-C₃)alkoxysilyl group and/or at least one chlorosilane group. Suitable tri(C₁-C₃)alkoxysilyl groups include e.g. trimethoxysilyl, triethoxysilyl, and tripropoxysilyl, and combinations thereof.

The functional group that is used as the “thermo-crosslinking unit” may have to be present in a protected form until it is needed, thereby using protective groups known to a skilled expert, as specified, for example, in Greene's Protective groups in organic synthesis (cf. complete citation above). In this context, the functionalization of the surface with the “molecule for surface attachment” carrying a protected “thermo-crosslinking unit” is carried out first. After this step, the protective groups are removed using a method known to the skilled expert, so that the “thermo-crosslinking unit” becomes available, without otherwise altering the chemical integrity of the polymer structure.

In the context of the present invention, a “thermo-crosslinking unit” may be selected from any suitable compound forming covalent bonds to a substrate and/or the polymer of the invention upon subjecting the compound to heat treatment, e.g —CH₂—CH₂—C₆H₄—SO₃—N₃, etc. or from those known in the art, e.g. from H. Dodiuk/S. Goodman, Handbook of Thermoset Plastics, 3^{rd} Edition, 2013.

To form a network from the inventive polymer on a substrate, the inventive polymer is applied to the (surface of a) substrate that has optionally been pre-treated as described in Step I and/or Step II above, and is then crosslinked by “thermo-activation” and/or “photo-activation” as defined above using an “internal crosslinker” and/or an “external crosslinker” as defined above.

In case an “external crosslinker” is used for said purpose, said “external crosslinker” as defined above is added to the inventive polymer, typically in solution, and the mixture is applied to the optionally pretreated surface (as described in Step I and/or Step II) above by immersion, spraying, spray-coating, spin coating or dip coating, pouring, coating with a doctor blade, etc., preferably via spin-coating or dip-coating. The “external crosslinker” carries “photo-crosslinking units” and/or “thermo-crosslinking units”, as defined above. The crosslinking units are activated by “photo-activation” and/or “thermo-activation”, as defined above.

In case an “internal crosslinker” is used for said purpose, said “internal crosslinker” is covalently attached to the inventive polymer and may be used by itself (i.e. without addition of an inventive polymer that does not carry “crosslinking units” as defined above), or in combination with the inventive polymer that does not carry “crosslinking units” as defined above. In either case, the “internal crosslinker” is typically dissolved in a suitable solvent, the inventive polymer that does not carry “crosslinking units” as defined above is optionally added to that solution, and the solution is applied to the optionally pretreated surfaces by immersion, spraying, spray-coating, spin coating or dip coating, pouring, coating with a doctor blade etc., preferably via spin-coating or dip-coating. The “internal crosslinker” carries “photo-crosslinking units” and/or “thermo-crosslinking units”, as defined above. The crosslinking units are activated by “photo-activation” and/or “thermo-activation”, as defined above.

Preferably, said “internal crosslinker” or “external crosslinker” carries at least two “photo-crosslinkable units” as defined above, which may be selected from any suitable photo-reactive functional group known to a skilled person to be photo-reactive, e.g. as defined before.

According to a further aspect, the antimicrobial and antifouling polymer of the invention may be applied to an (optionally pretreated) surface as defined herein via a “thermo-crosslinking unit” which is part of a “molecule for surface attachment” as defined before, and/or a “thermo-crosslinking unit” which is part of an “internal crosslinker” or an “external crosslinker”. In the context of the present invention, such a “thermo-crosslinking unit” may be selected from any suitable compound forming covalent bonds to the polymer of the invention upon subjecting the compound to heat treatment, e.g. the fragment —CH₂—CH₂—C₆H₄—SO₃—N₃, or another group known to those skilled in the art, e.g. from H. Dodiuk/S. Goodman, Handbook of Thermoset Plastics, 3^{rd} Edition, 2013.

The functional group that is used as the “thermo-crosslinking unit” may have to be present in a protected from until it is used. If part of the “internal crosslinker”, it may have to be present in a protected form until after the ring-opening metathesis polymerization reaction by which the inventive polymer is formed, using protective groups known to a skilled expert, as specified, for example, in Greene's Protective groups in organic synthesis (cf. complete citation above). After polymerization, the protective groups are then removed using a method known to the skilled expert, so that the “thermo-crosslinking unit” crosslink becomes available, without otherwise altering the chemical integrity of the polymer structure.

In another preferred embodiment, the above-described approaches for “crosslinking” to form a network (e.g. using a “crosslinker” as defined above), and to a obtain covalent attachment of the inventive polymer to the surface (e.g. using a “molecule for surface attachment”) may be used in combination, e.g. by using a “molecule for surface attachment” with “photo-crosslinking units” and/or “thermo-crosslinking units” to attach the antimicrobial and antifouling polymer of the present invention to an (optionally pre-treated) surface, and a “crosslinker” carrying “thermo-crosslinking units” and/or “photo-crosslinking” units for preparing a polymer network of the inventive a polymer.

In another preferred embodiment, the above-described approaches for “crosslinking” to form a network (e.g. using a “crosslinker” as defined above), and for “crosslinking” to obtain covalent attachment of the inventive polymer to the surface (e.g. using a “molecule for surface attachment”) may be used in combination, e.g. by using a “molecule for surface attachment” with “photo-crosslinking units” to attach the antimicrobial and antifouling polymer of the present invention to an (optionally pre-treated) surface, and a “crosslinker” carrying “thermo-crosslinking units” for preparing a polymer network of the inventive a polymer.

In another preferred embodiment, the above-described approaches for “crosslinking” to form a network (e.g. using a “crosslinker” as defined above), and for “crosslinking” to obtain covalent attachment of the inventive polymer to the surface (e.g. using a “molecule for surface attachment”) may be used in combination, e.g. by using a “molecule for surface attachment” with “thermo-crosslinking units” to attach the antimicrobial and antifouling polymer of the present invention to an (optionally pre-treated) surface, and a “crosslinker” carrying “photo-crosslinking” units for preparing a polymer network of the inventive a polymer.

In this context, an “external crosslinker” as defined above may carry thiol groups as “photo-crosslinking units”, which may react with the inventive polymer via a thiol-ene-reaction, forming covalent bonds between the inventive polymer via their double bonds, thus forming a polymer network. For this variant, the polymers of the invention are preferably mixed with a multifunctional external crosslinker, preferably a di-, tri-, tetrafunctional or multifunctional external crosslinker, preferably a multifunctional external thiol crosslinker, more preferably a di-, tri- or even tetrafunctional external thiol crosslinker, which allows crosslinking of the inventive polymers to form a crosslinked network by typically photo-activation. In this context, the term “multifunctional” preferably refers to the number of thiol-moieties or SH-moieties of such a crosslinker compound, e.g. 2, 3, 4, 5, 6, 7, 8, 9, 10 or even more thiol-moieties or SH-moieties may be contained in such a multifunctional external thiol crosslinker.

Thus, crosslinking the inventive antimicrobial and antifouling polymers to form a polymer network on the surface of the substrate using the “external crosslinker” occurs via activation of the reaction between the double bonds present in the inventive polymers and the thiol groups of the “external-crosslinker” as defined above. e.g. via “thermo-activation” and/or “photo-activation” as described above. Thereby, two different chains of the inventive polymer or different segments of one chain of the inventive polymer react with different “crosslinking units” of the “external crosslinker”, by which process overall a polymer network is formed. Generally, for this purpose, a solution of polymers of the invention, optionally in their protected form, and external crosslinker, e.g. a multifunctional crosslinker as defined herein, e.g. a tetrafunctional thiol crosslinker (SH), may be mixed and then spin-coated, dip-coated or spray-coated onto the surface of a substrate, or the mixture may be kept in solution. Upon “photo-activation”, e.g. irradiation with UV light, the polymer chains are crosslinked to neighboring polymer chains of other polymers through the multifunctional thiol moieties. An optional deprotection step then yields the inventive antimicrobial and antibiofouling polymer.

Alternatively, the thiol-ene crosslinking of the inventive antimicrobial and antifouling polymers with each other using the “external crosslinker” may occur simultaneously to attaching the inventive polymers to the surface of a substrate using a “molecule for surface attachment” as already indicated above. Generally, for this purpose, a solution of polymers of the invention, optionally in their protected form, and a multifunctional crosslinker as defined herein, e.g. a tetrafunctional thiol crosslinker (SH), may be spin-coated onto the surface of a substrate that has been preferably pretreated as mentioned above using a “molecule for surface attachment” carrying a “photo-crosslinking unit”, e.g. a benzophenone group or another suitable “photo-crosslinking unit” as defined above. Upon “photo-activation”, e.g. irradiation with UV light, the inventive polymer is simultaneously attached to the surface through “molecule for surface attachment” carrying a “photo-crosslinking unit”, e.g. the benzophenone crosslinker, and to neighboring chains of the inventive polymer or to other polymers of the invention, to form a crosslinked polymer network.

Preferably, a multifunctional crosslinker for the “thiol-ene crosslinking approach” is selected from a di-, tri-, tetrafunctional or multifunctional crosslinker, preferably a multifunctional thiol crosslinker, more preferably a di-, tri- or even tetrafunctional thiol crosslinker, e.g. 1,2-ethanedithiol, 1,3-propane trithiol, analogous higher bifunctional homologoues thereof, analogous tri- and tetrafunctional aliphatic homologoues thereof including ethane-1,1,2,2-tetrathiol, ethene-1,1,2,2-tetrathiol, and pentaerythryltetrathiol (=2,2-bis(mercaptomethyl)propane-1,3-dithiol, the structures shown in formula (IV) and (V)

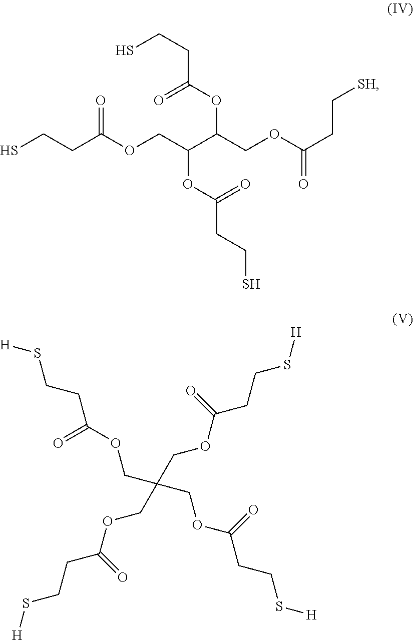 [SMILES: O=C(CCS)OCC(OC(=O)CCS)C(COC(=O)CCS)OC(=O)CCS ; O=C(CCS)OCC(COC(=O)CCS)(COC(=O)CCS)COC(=O)CCS]

2,2′-(ethylenedioxy)diethanethiol and higher bifunctional homologoues thereof such as tetra(ethylene glycol) dithiol and hexa(ethylene glycol) dithiol, ananolgous trifunctional ethylenen glycol and polyethylen glycol thiols, and analogous ethylenen glycol and polyethylen glycol tetrafunctional thiols, 1,4-benzenedimethanethiol and analogous bi-, tri, or tetrafunctional aromatic thiols including 2,2-bis(sulfanylmethyl)propane-1,3-dithiol), benzene-1,2,4,5-tetrathiol, SH-functionalized nanoparticles, etc.

In this context, an “internal crosslinker” consists of repeat units as defined by formula (I), and a small fraction of repeat units (0.05% to 10%) where the Z groups of formula (I) have been replaced by “crosslinking units” as defined above thereby forming repeat units as defined by formula (I′) as defined above. Hence, polymers may be formed, comprising both repeat units as defined by formula (I) and repeat units as defined by formula (I′), containing preferably repeat units as defined by formula (I′) in amounts as defined above. Alternatively, as defined before, polymers may be prepared comprising repeat units as defined by formula (I) and distinct polymers may be prepared comprising repeat units as defined by formula (I′), wherein such polymers based on repeat units as defined by formula (I) and polymers based on repeat units as defined by formula (I′) are present in amounts and ratios as defined above for forming polymeric networks as described above.

Alternatively, the “internal crosslinker” may be obtained by copolymerization of the inventive monomer/s with a monomer that carries a “crosslinking unit” Z′. This is illustrated in formula (VI)

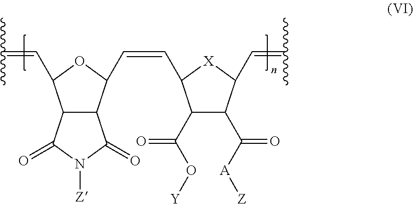

In this context, X, A, Y and Z are as defined above for formula (I). Furthermore, Z′ can be CH₂CH₂O—C₆H₄—C(═O)—C₆H₅ as described in the Examples, or any other “thermo-crosslinking unit” or “photo-crosslinking unit” as described above known to those skilled in the art. The “internal crosslinker” is thus a self-crosslinking variant of the inventive polymer.

For this variant of network formation, the polymers of the invention are preferably either mixed with the multifunctional internal crosslinker, or said internal crosslinker can be used by itself instead of the inventive polymers. Thus, to coat a surface using the “internal crosslinker” approach, either the internal crosslinker by itself or a mixture of the inventive polymer and the internal crosslinker are preferably dissolved in an appropriate solvent and applied to the surface by preferably spin-coating or dip-coating, as defined below. If the “internal crosslinker” carries “photo-crosslinking units”, the surface is subsequently subject to “photo-activation”. If the “internal crosslinker” carries “thermo-crosslinking units”, the surface is subsequently subject to “thermo-activation”.

According to a first particular preferred aspect, a surface as defined herein is preferably coated with an inventive antimicrobial and antifouling polymer according to the following steps:

a) optionally pretreating a surface of a substrate as defined herein in Step I to comprise oxide or hydroxide groups;
b) optionally functionalizing the optionally pretreated surface by a “molecule for surface attachment” as defined above in Step II, comprising at least one “photo-crosslinking unit” and/or at least one “thermo-crosslinking unit” as defined above, and at least one “reactive group” as defined above.
c) coating the surface with the (protected) inventive polymer as prepared according to the present invention, optionally adding an “external crosslinker” and/or an “internal crosslinker” as defined above, onto the surface that has optionally been pretreated with according to step a) and/or step b).
d) irradiating with UV light and/or heating the surface obtained according to step c).
e) optionally carrying out a post-irradiation/post-heating treatment of the coating obtained by step d), such as deprotection as defined herein, e.g. with an acid as defined herein, and/or carrying out washing steps.

The steps individual may be carried out as generally defined herein.

According to a second particular preferred aspect, a surface as defined herein is preferably coated with an inventive polymer according to the following steps:

a) optionally pretreating a surface of a substrate as defined herein in Step I to comprise oxide or hydroxide groups;
b) functionalizing the surface that has been optionally pretreated according to step a) by a “molecule for surface attachment” containing as a “reactive group” a silane, thiol or disulfide compound, and comprising a “thermo-crosslinking unit” as defined herein in Step II.
c) coating the surface with the (protected) inventive polymer as prepared according to the present invention, optionally adding an “internal crosslinker” or an “external crosslinker” carrying “thermo-crosslinking units”, onto the surface as obtained according to step b),
d) heating the surface comprising the “molecule for surface attachment” carrying “thermo-crosslinking units” and the optionally present “internal crosslinker” or an “external crosslinker” carrying “thermo-crosslinking units”, thereby covalently binding the (protected) inventive polymer to the surface through the “molecule for surface attachment”, and optionally crosslinking it to form a surface-attached network,
e) optionally carrying out a post-irradiation treatment of the covalently bound inventive polymer as obtained by step d) by deprotection as defined herein, e.g. with an acid as defined herein, and/or carrying out washing steps.

The steps individual may be carried out as generally defined herein.

According to a third particular preferred aspect, a surface as defined herein is preferably coated with an inventive polymer according to the following steps:

a) optionally pretreating a surface of a substrate as defined herein in Step I to comprise oxide or hydroxide groups;
b) functionalizing the surface that has been optionally pretreated according to step a) by a “molecule for surface attachment” containing as a “reactive group” a silane, thiol or disulfide compound, and comprising a “photo-crosslinking unit” as defined herein in Step II.
c) coating the surface with the (protected) inventive polymer as prepared according to the present invention, optionally adding an “internal crosslinker” or an “external crosslinker” carrying “photo-crosslinking units”, onto the surface as obtained according to step b),
d)) irradiating the surface comprising the“molecule for surface attachment” carrying “photo-crosslinking units” and the optionally present “internal crosslinker” or an “external crosslinker” carrying “photo-crosslinking units”, thereby covalently binding the (protected) inventive polymer to the surface through the “molecule for surface attachment”, and optionally crosslinking it to form a surface-attached network,
e) optionally carrying out a post-irradiation treatment of the covalently bound inventive polymer network as obtained by step d) by deprotection as defined herein, e.g. with an acid as defined herein, and/or carrying out washing steps.

The steps individual may be carried out as generally defined herein.

Alternatively, the surface coating reaction according to the third aspect may be carried out by using a “molecule for surface attachment” carrying a “thermo-crosslinking unit” for functionalizing the pretreated surface in step b), by adding an “internal crosslinker” or an “external crosslinker” carrying “photo-crosslinking units” in step c), and by heating the surface comprising the “molecule for surface attachment” carrying a “thermo-crosslinking unit”, thereby covalently binding the (protected) inventive polymer to the surface via the “thermo-crosslinking unit” of the “molecule for surface attachment”, and subsequently irradiating the present “internal crosslinker” or “external crosslinker” carrying “photo-crosslinking units” with UV light, thereby further crosslinking the inventive polymer to form a surface attached network.

A monolayer surface coating prepared with the inventive antimicrobial and antifouling polymer as described above may comprise a thickness of about 2 nm to about 50 nm. An optionally surface-attached network prepared with an inventive antimicrobial and antifouling polymer as described above may comprise a thickness of about 10 nm to 10 μm.

The thickness of the surface coating layer may be dependent on the different methods used for application. Preferably, the thickness of the antimicrobial and/or antifouling (protein-repellent) surface coating layer, comprising the protected or already deprotected inventive polymer, may be about 50 nm to about 500 nm.

Preferably, applying the different compounds and/or compositions as defined above to the surface as defined herein and hence coating the surface may occur using any technique known to a skilled person to apply a liquid or semi-liquid compound to a surface, e.g. via a technique, such as immersion, spraying, spray-coating, spin coating or dip coating, pouring, doctor blading, etc., preferably via spin-coating or dip-coating.

In this context, “spin coating” is typically a procedure used to apply uniform thin films to flat or other surfaces of a substrate, wherein an excess amount of a solution is usually placed on the surface, which is then rotated at high speed in order to spread the excess fluid by centrifugal force. Machines suitable for the inventive purpose preferably include spin coater or spinner. Typically, four distinct stages may be defined during the spin coating process: 1) Deposition of the coating fluid onto the surface of a substrate, e.g. by using a nozzle, pouring the coating solution or by spraying it onto the surface. A substantial excess of coating solution is usually applied compared to the amount that is required. 2) Acceleration of the substrate up to a final, desired, rotation speed. 3) Spinning of the substrate at a constant rate, wherein fluid viscous forces dominate the fluid thinning behavior. 4) Optionally spinning of the substrate at a constant rate, wherein solvent evaporation dominates the coating thinning behavior. In the continuous process, the steps are carried out directly after each other.

Furthermore, “dip-coating” is typically a procedure used to apply uniform thin films onto flat or cylindrical/round-shaped or otherwise shaped surfaces of substrates and typically can be separated into five stages: 1) Immersion: The substrate is preferably immersed in the solution of the coating material, either without or at a constant speed. 2) Start-up: The substrate preferably remains inside the solution for a while and is started to been pulled up. 3) Deposition: The thin layer is preferably deposited on the substrate while it is pulled up. The withdrawing is optionally carried out by rotating at a preferably constant speed. The speed determines the thickness of the coating. 4) Drainage: Excess liquid usually drains from the surface. 5) Optionally evaporation: The solvent may evaporate from the liquid, forming the thin layer. In the continuous process, the steps are carried out directly after each other.

Preferably, the surface as defined above, preferably a pretreated and functionalized as described above, may be coated as defined above, e.g. with the polymer of the invention via spin coating or dip-coating.

Preferably, the antimicrobial and antifouling polymer of the invention may be used to prepare a polymer monolayer, a polymer network, or a multi-stack of polymer networks on the surface of the substrate. The “internal crosslinker” and “external crosslinker” described above used to form a polymer network with the inventive antimicrobial and antifouling polymer also allows for preparing further layers or network structures on a polymer coating already present on the surface of the substrate. The polymer coating already present is a coating of the inventive polymer or another polymer, preferably a coating of the inventive polymer. By this method of coating, a multi-layered crosslinked polymer network coating can be advantageously prepared. The multi-layered crosslinked polymer network coating is associated with the advantageous properties of higher layer thickness and/or more homogeneous surface coverage. Furthermore, such layers may show a significantly increased resistance towards damages of the surface layer.

In a preferred method of forming a multi-layered crosslinked polymer network on a substrate, the steps c), d) and e) of the above method are repeated at least twice, preferably two times to twenty times, more preferably two to five times, and especially preferred about two times.

As defined above, the polymer of the invention can be covalently attached to a surface to obtain an antimicrobially active and antifouling (protein-repellent) surface. Preferably, such a surface coating layer has a thickness of about 10 nm to about 1000 μm, preferably a thickness from about 10 nm to about 100 μm, to about 200 μm, to about 300 μm, to about 400 μm, to about 500 μm, to about 600 μm, to about 700 μm, to about 800 μm, to about 900 μm, to about 1000 μm, to about 2000 μm, to about 3000 μm, likewise from about 100 nm, 500 nm or 1000 nm to any of the above defined upper values, etc.

Preferably, the coating exhibits antimicrobial properties. The antimicrobial activity of the coating comprising the polymer according to the present invention can be determined by the standard procedures for antimicrobial activity determination defined above.

The antimicrobial activity of the coating comprising the polymer according to the present invention can be determined by standard procedures, e.g., by JIS Z 2801:2000, or those described by Haldar et al. Nature Protocols 2007, 2(19), 2412 or by Al-Ahmad et al., PLoS One 2014, e111357.

Preferably, the coating exhibits protein-repellency and/or antifouling properties. The antifouling activity of the coating comprising the polymer according to the present invention can be determined, for example, by surface plasmon resonance spectroscopy, as described above. Generally, methods for detecting antimicrobial and/or antifouling activity are carried out as indicated initially.

In another aspect, the present invention provides a material, substrate or product, the surface of which is coated with a polymer according to the present invention.

Finally, according to a last embodiment, the present invention provides uses of the inventive antimicrobial and antifouling polymer, polymeric networks formed therewith and substrates and materials as described herein. The present invention particularly concerns the use of the inventive antimicrobial and antifouling/protein-repellent polymer, polymeric networks formed therewith and substrates and materials as described herein as a medical preparation or formulation. The present invention also concerns the use of the inventive antimicrobial and antifouling polymer, polymeric networks formed therewith and substrates and materials as described herein for treating and/or preventing microbial infections in a patient.

Hence, the antimicrobial and antifouling polymer according to the invention or the polymeric network according to the invention or the substrate according to the invention may be provided for use as a drug or for use in treating or preventing microbial infections in a patient.

Additionally, the invention concerns the use of the inventive antimicrobial and antifouling polymer, polymeric networks formed therewith and substrates and materials as described herein for preventing microbial growth and biofouling, preferably on a substrate, device or tool.

In the present invention, if not otherwise indicated, different features of alternatives, aspects and embodiments may be combined with each other, if suitable. Furthermore, the term “comprising” shall not be construed as meaning “consisting of”, if not specifically mentioned. However, in the context of the present invention, term “comprising” may be substituted with the term “consisting of”, where applicable.

### FIGURES

The figures shown in the following are merely illustrative and shall describe the present invention in a further way. These figures shall not be construed to limit the present invention thereto.

FIG. 1: illustrates the structure and synthesis of the inventive antimicrobial and antifouling polymer, a carboxybetain-based polyzwitterion (PZI, 1), as shown in FIG. 1. PZI 1 is obtained via a protective group approach. The PZI monomer precursor 2 carries a tert-butoxy carbamate (Boc) protective group on the primary amine. It is obtained in a one-step reaction from oxonorbornene-anhydride 3 and N-Boc-ethanolamine 4. Polymerization by Grubbs IIIrd generation catalyst (G3) in dichloromethane yields the polymer in its protected form (5). Gel permeation chromatography (in THF) showed that high molecular weights up to 73,000 g mol⁻¹, with a polydispersity index of 1.5 g mol⁻¹, were easily available. The Boc protective group was removed by hydrochloric acid in dioxane, giving the desired PZI 1.

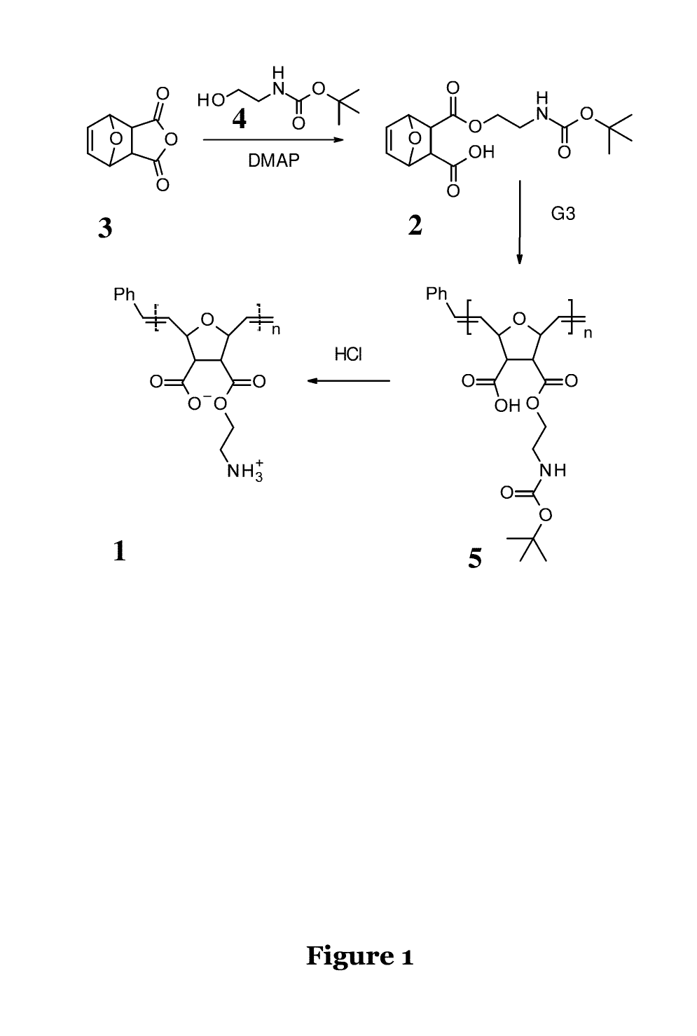

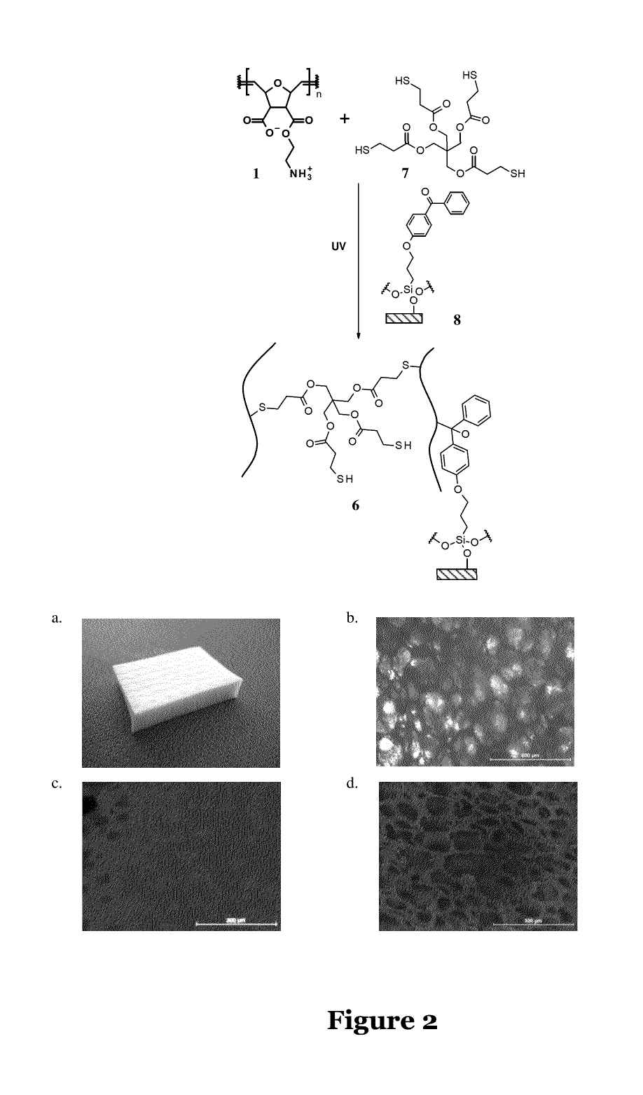

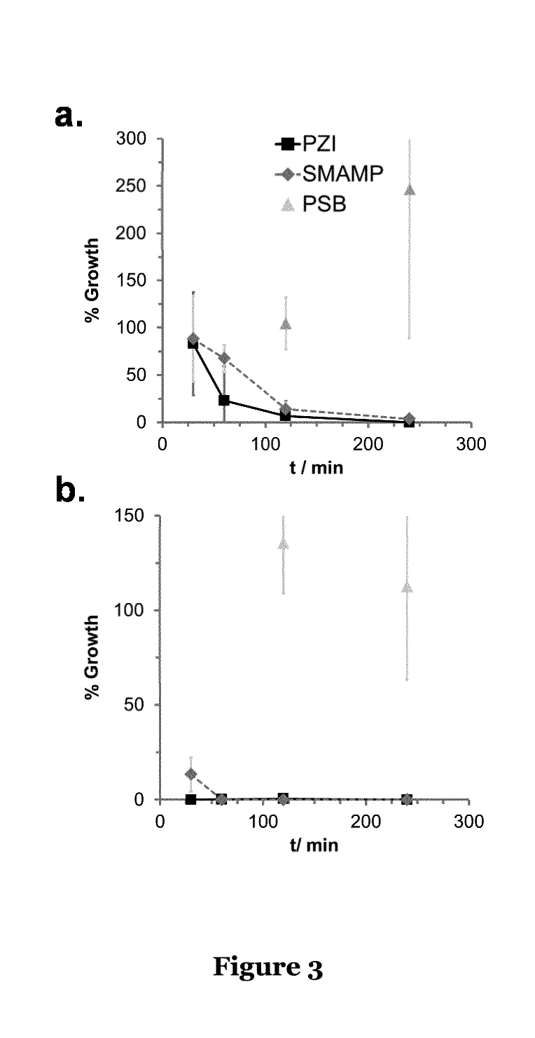

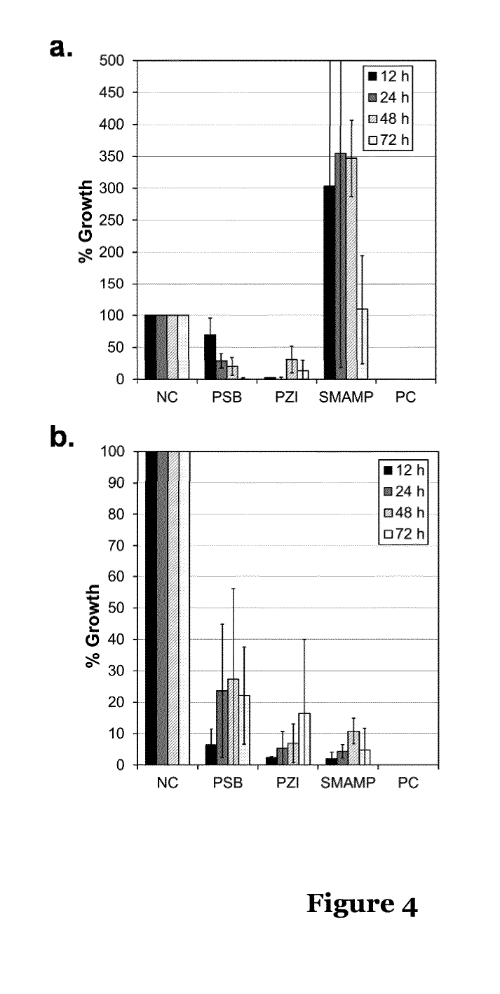

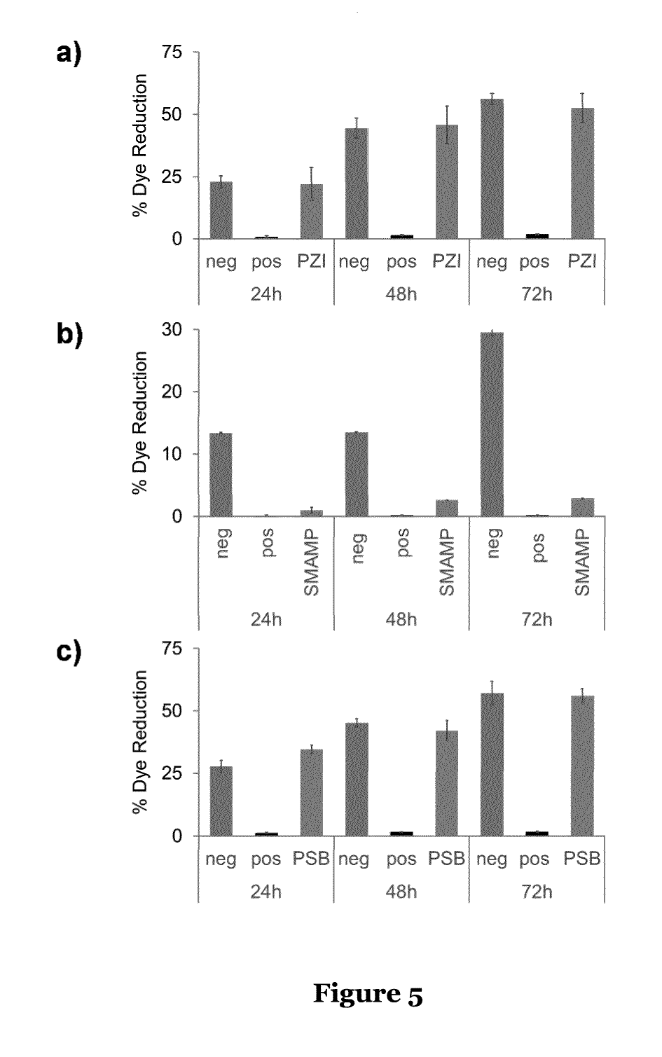

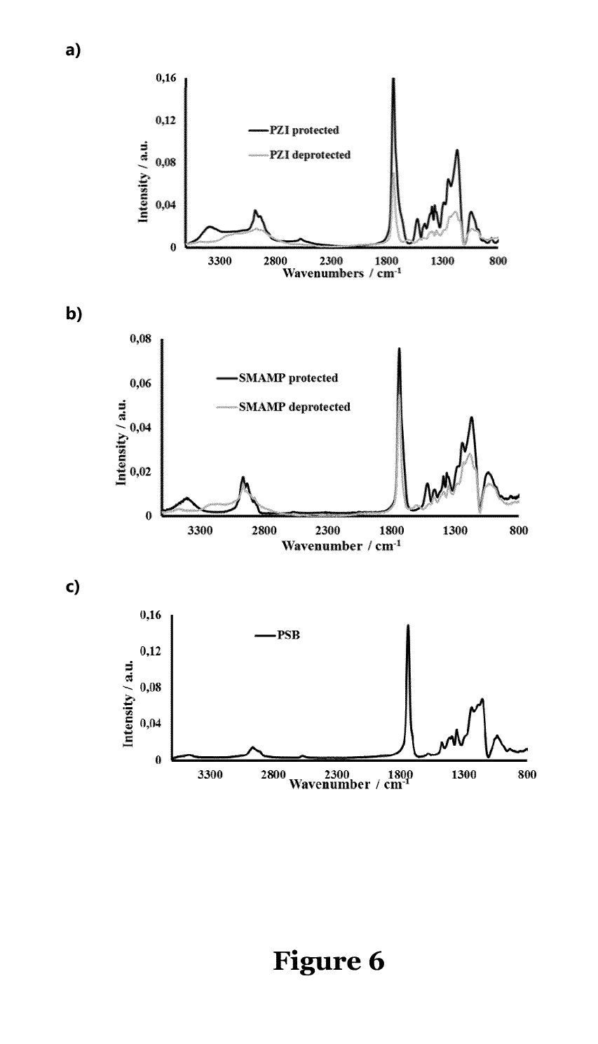

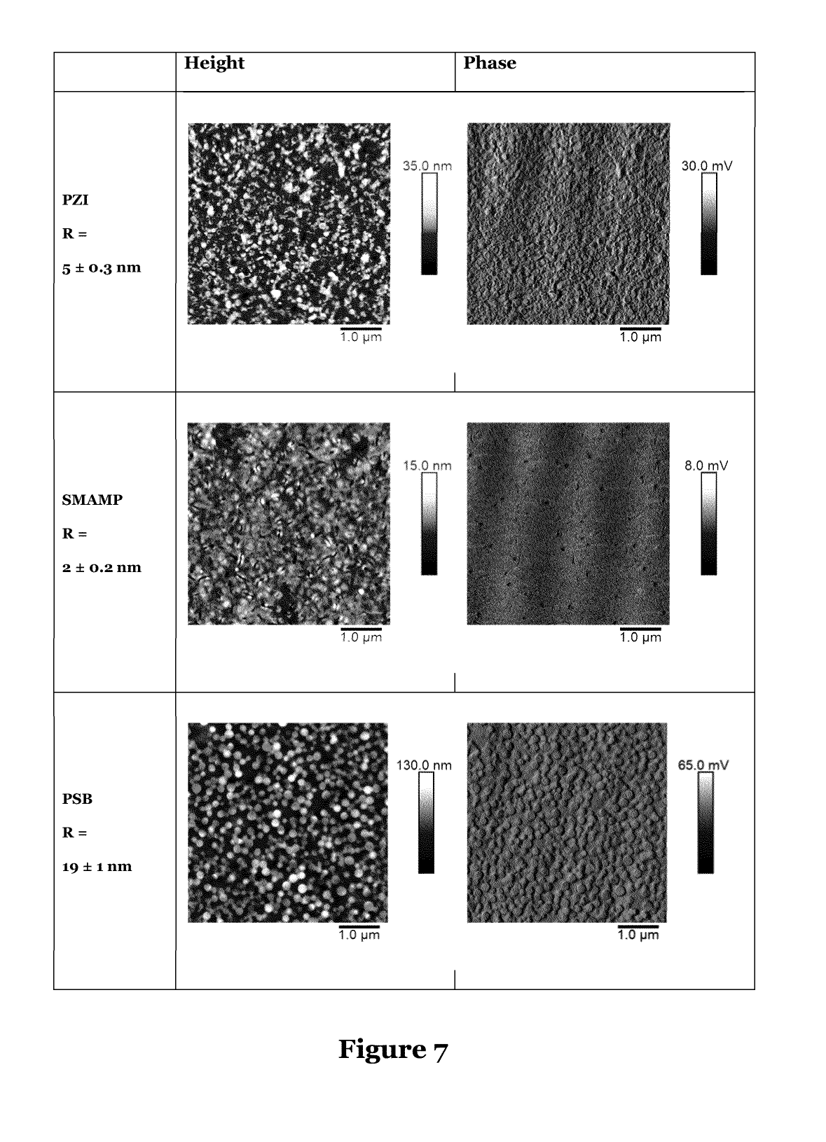

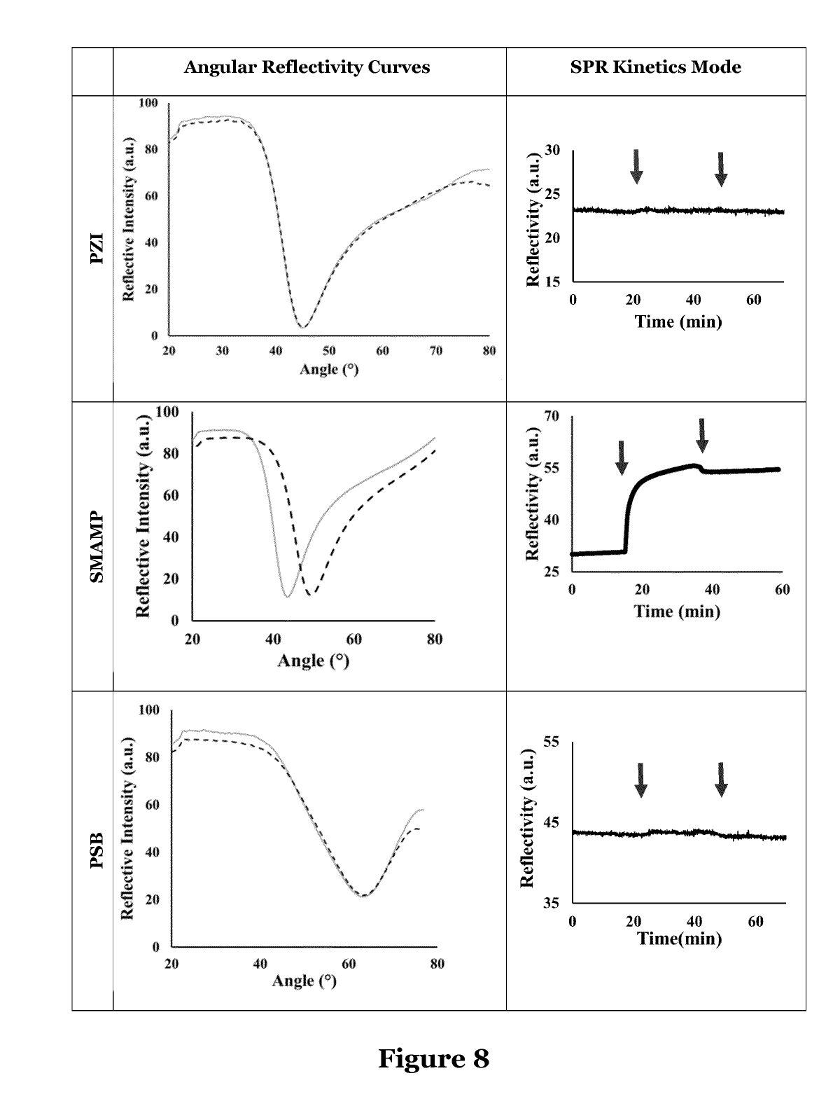

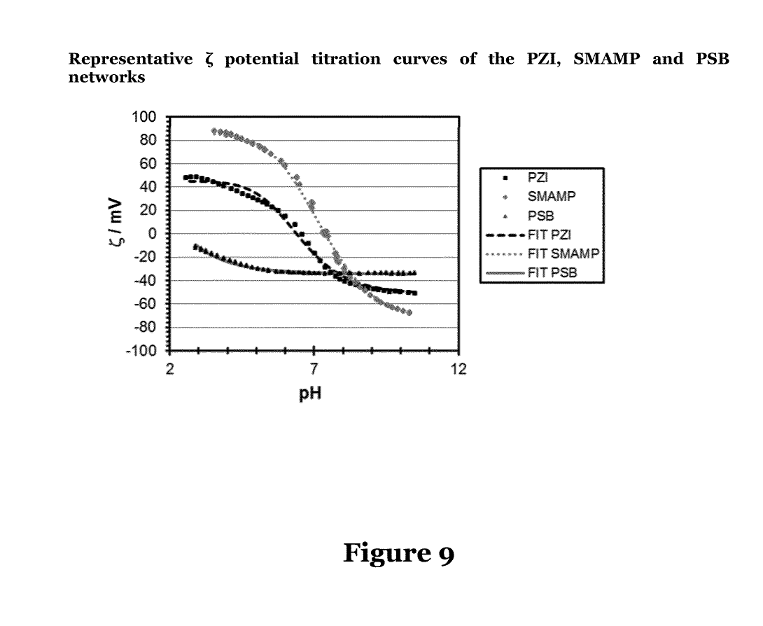

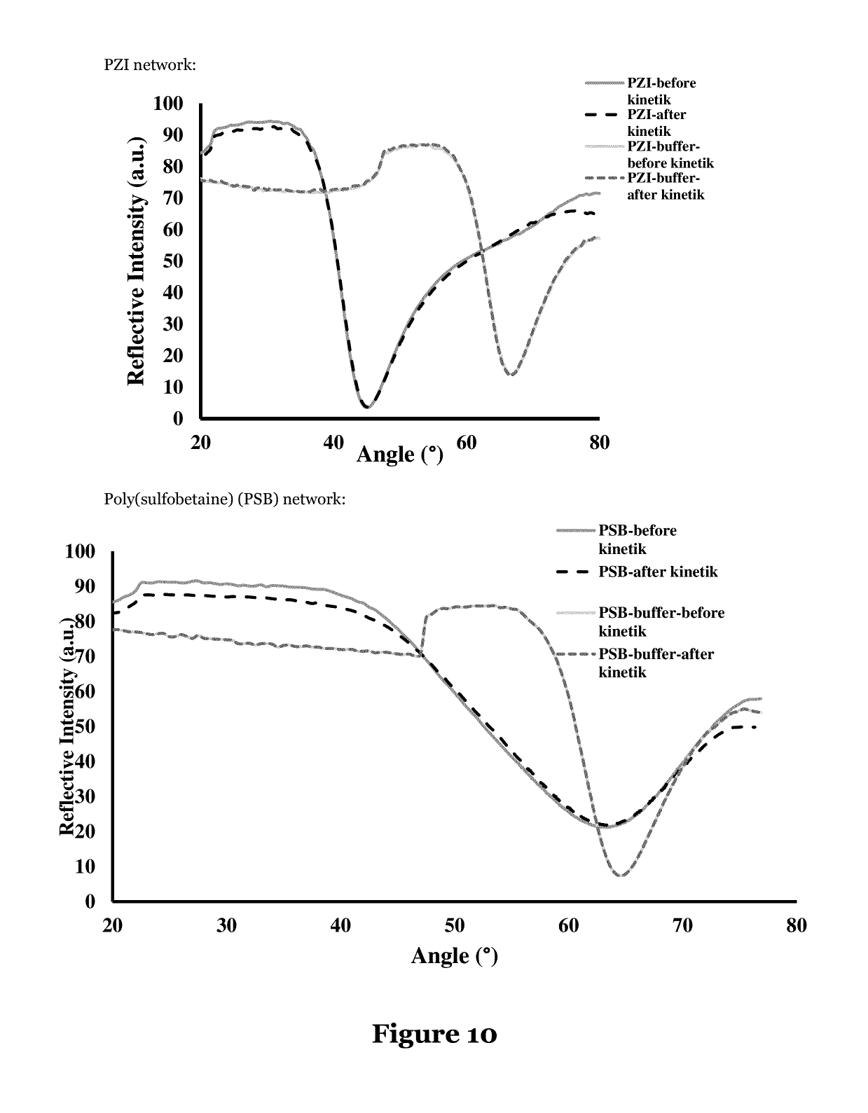

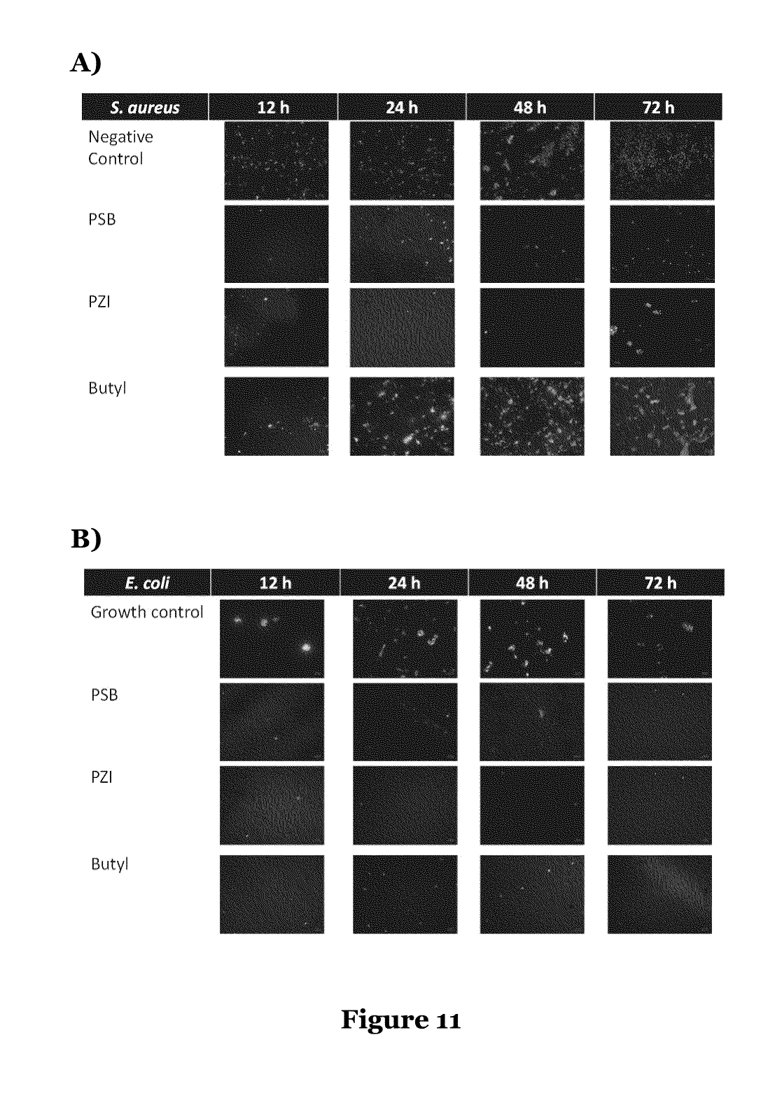

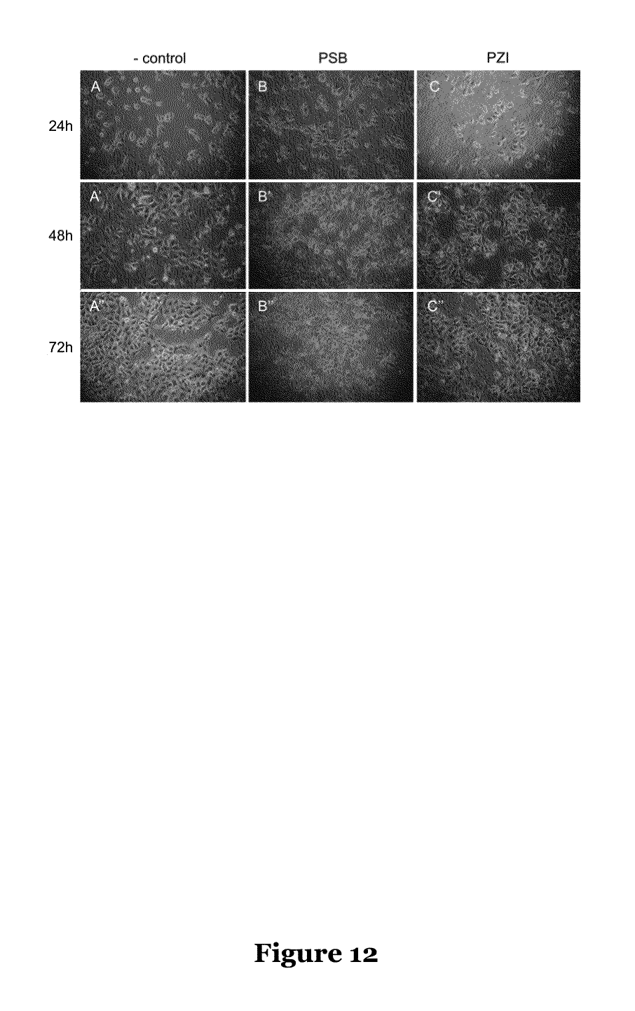

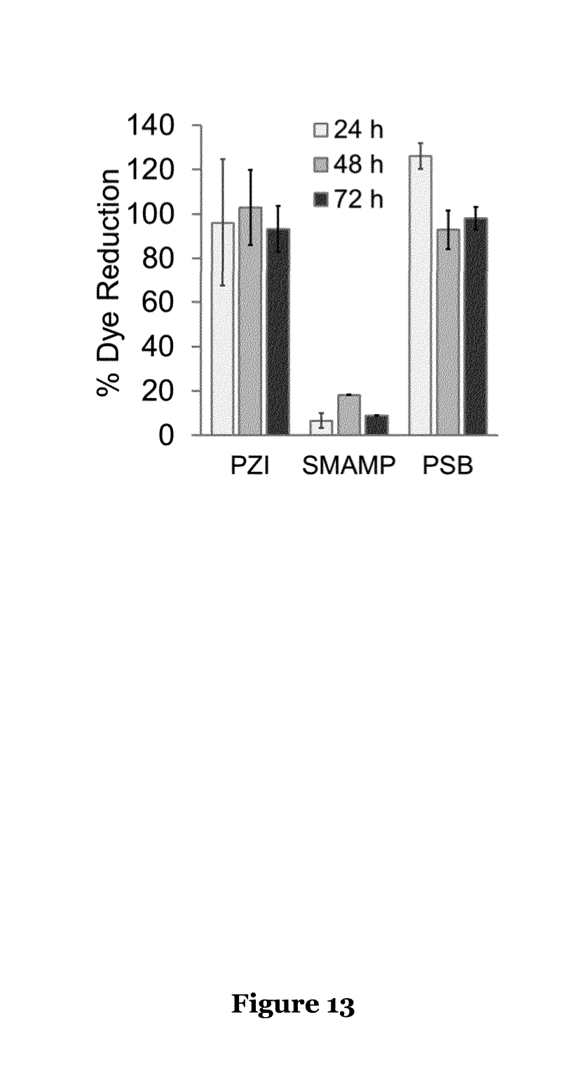

FIG. 2: illustrates in the top section exemplarily how PZI coated surfaces (6) were obtained by applying PZI 1 and the “external crosslinker” 7 (carrying thiol groups as “photo-crosslinking units”) to a surface 8 that has been pretreated by a “molecule for surface attachment” carrying benzophenone as a “photo-crosslinking unit” and a silane as a “reactive group”. UV irradiation triggers two UV-activated reactions simultaneously: the CH-insertion reaction between aliphatic CH groups of the PZI 1 and keto groups of a benzophenone-pretreated substrate 8 (which causes covalent attachment between the PZI and the “molecule for surface attachment”) and the thiol-ene reaction between the PZI double bonds and the thiol groups of the “external crosslinker” 7, which causes network formation. Overall, a surface-attached polymer network is thus obtained. The process is not limited to standard laboratory surfaces like glass, silicon wafers or quartz, but works on many technical surfaces that carry OH groups or can be oxidized by simple plasma cleaning. This includes most medical plastics and many medically important metals including titanium and aluminum.
The process as described in FIG. 2 works with the deprotected PZI 1, or its protected version 6.
FIG. 2, shows in the bottom section commercially available polyurethane (PU) wound dressing foam coated with PZI: a. photograph of a piece of PU foam (thickness 5 mm); b. optical micrograph of the uncoated PU foam showing the porous structure; c. fluorescence micrograph of the uncoated PU foam (exposure time 100 ms); d. fluorescence micrograph of the PZI-coated PU foam (exposure time 10 ms; for this image, the Coumarin-labeled PZI used).

FIG. 3: illustrates the assessment of the antimicrobial activity of the PZI coated surface 6 (see also FIG. 2) compared to two reference surfaces, the strongly antimicrobial butyl SMAMP (as described in P. Zou, D. Laird, E. K. Riga, Z. Deng, H.-R. Perez-Hernandez, D. L. Guevara-Solarte, T. Steinberg, A. Al-Ahmad, K. Lienkamp, Journal of Materials Chemistry B 2015, 3, 6224-6238) and the strongly protein-repellent PSB network (as described in S. Colak, G. N. Tew, Langmuir 2012, 28, 666-675). These reference polymers were immobilized as surface-attached networks using the same process as described above for the PZI. By comparing the PZI to these structurally similar materials which either had only an antimicrobial effect (i.e. intrinsic antimicrobial activity), or only an anti-adhesive effect, but no intrinsic antimicrobial activity, the unique properties of the inventive PZI can be appreciated.
This figure shows time-kill experiments on the PZI 6, the SMAMP and the PSB networks. The experiments were performed using standardized procedures. In short, the test surfaces were sprayed with either Gram negative E. coli bacteria, or Gram positive S. aureus bacteria (at 10⁶ bacteria per cm³). After different incubation times on the test surfaces, the surviving bacteria were plated out on agar plates, where they were further incubated, and counted. In this figure, the number of colony forming units, in percent, relative to the negative control, is plotted versus incubation time. Thus, this assay quantifies the relative amount of viable bacteria after a certain exposure to the surface. The data indicates that both PZI and SMAMP were highly active against S. aureus (a). Surprisingly, the PZI killed S. aureus faster and more quantitatively than the strongly antimicrobial SMAMP. While there was a residual growth of 3.7% for the SMAMP after 4 h, the growth after 4 hours PZI exposure was 0.0% (i.e. at the detection limit of the method). Both surfaces quantitatively killed E. coli bacteria (b, 0.0% growth after 4 h, FIG. 3b.). The protein-repellent PSB had growth rates >100% for all time points studied and was thus, as predicted, not antimicrobial.

FIG. 4: Shows the results of biofilm formation experiments. In these biofilm formation experiments, E. coli and S. aureus bacteria were grown on the test substrates over 72 hours in the presence of nutrients. After defined time points, the growing biofilm was stained using the BacLight Bacterial Viability Kit. This kit stains membrane-compromised cells red, while all cell are stained green by a fluorescent dye able to permeate intact membranes. We only considered the changes in green fluorescence as a quantity that measures of total biomass produced on the surface, irrespective of the fact that this biomass consists of living and membrane compromised, ‘dead’ cells. To that end, the fluorescence intensity of several fluorescence microscopy images was recorded at different time points, and that intensity was compared to the untreated silicon control surface (NC, =100% growth). For S. aureus (a), the data shows that substantially less biofilm is formed on the two polyzwitterions PSB and PZI, compared to the negative control. However, PSB, which is not antimicrobial, had 70% growth after 12 h compared to the negative control, while PZI had below 3%. On the polycationic SMAMP, on the other hand, the growth of S. aureus is dramatically increased compared to the negative control, which indicates that live bacteria can settle on the debris of the killed bacteria. The biofilm growth of E. coli (b) is significantly reduced on all test surfaces, compared to the negative control. SMAMP and the PZI had similarly low biofilm growth rates when exposed to E. coli, while the non-antimicrobial PSB was slightly more covered with bacteria.

FIG. 5: To test the biocompatibility of the PZI network, the Alamar Blue assay, (R. Hamid, Y. Rotshteyn, L. Rabadi, R. Parikh, P. Bullock, Toxicology in Vitro 2004, 18, 703-710) a standard cell toxicity assay, was used. In this assay, immortalized, non-carcinogenic human keratinocytes were seeded on the test surfaces, and cultivated. As living cells metabolize the Alamar Blue dye, the dye reduction compared to various controls is an indication of cell viability. FIG. 5 shows an Alamar Blue dye reduction (relative to initial dye concentration) by human keratinocytes grown for 24, 48 and 72 h, respectively, on PZI, SMAMP and PSB. The dye reduction by PZI and PSB was comparable to that of the growth control (neg). The dye reduction of the positive control corresponds to no cell growth. The figure shows the growth of keratinocytes on PZI within 72 h relative to a positive and negative control as defined in the Examples. The data shows that the cell growth is reduced to 49-55% of the value obtained for the negative control. Optical microscopy and fluorescence microscopy data (not shown) confirmed that the cells that grew on PZI were healthy and not membrane-compromised.

FIG. 6: shows FTIR spectra of the PZI network (a), the SMAMP network (b), and the PSB network (c.)

FIG. 7: illustrates the results from a atomic force microscopy (AFM). The topography of the surfaces was imaged with a Dimension FastScan and Icon from Bruker. Commercial FastScan-A cantilevers (length: 27 μm; width: 33 μm; spring constant: 18 Nm⁻¹; resonance frequency: 1400 kHz) and ScanAsyst Air cantilevers (length: 115 μm; width: 25 μm; spring constant: 0.4 Nm⁻¹; resonance frequency: 70 kHz) were used. All AFM images were recorded in tapping mode in air and ScanAsyst in air, respectively. The obtained images were analyzed and processed with the software ‘Nanoscope Analysis 9.1’. For each sample, the root mean square (RMS) average roughness R from three images of an area of 5×5 μm² at different positions was taken.

FIG. 8: illustrates the results of protein adsorption on the PZI 6 and the two reference surfaces. The experiment was conducted as described. Right column: kinetics curve (reflectivity at constant angle vs. time). The first arrow marks the time point when protein (here: fibrinogen) was injected; the second arrow indicates the time point of buffer injection. Left column: reflectivity curves (reflectivity vs. angle) of the dry samples before (grey) and after (black dashed) protein adhesion. The data indicates that protein adhered strongly to the SMAMP, while both PSB and PZI 6 had quantitative protein repellency (within the accuracy limit of the method).

FIG. 9: shows representative ζ potential titration curves of the PZI, SMAMP and PSB networks for PZI-networks, SMAMP-networks and PSB-networks

FIG. 10: shows the results from SPR Kinetics Experiments. For PZI-networks and PSB-networks as formed herein.

FIG. 11: demonstrates the effectiveness of PZI-networks against biofilm formation. As can be seen in FIG. 11, top, PZI significantly inhibited biofilm formation in the presence of S. aureus (see FIG. 11 Biofilm formation of S. aureus on PZI, SMAMP (=Butyl) and PSB (compared to the negative control (=growth control) after 12, 24, 48 and 72 h. The images are overlay of the green fluorescence and the red fluorescence. Biofilm formation was significantly inhibited in the presence of E. coli on PZI. Shown are also as comparative polymers SMAMP (=Butyl) and PSB, compared to negative control (compared to the negative control (=growth control) after 12, 24, 48 and 72 h. The images are an overlay of the green fluorescence and the red fluorescence.

FIG. 12: shows optical micrographs (phase contrast) of human keratinocytes grown on an uncoated glass slide (−control, growth control), PSB and PZI after 24 h (A to C), 48 h (A′ to C′) and 72 h (A″ to C″). The cell density and the cell morphology on PSB and PZI is comparable to that on the growth control.

FIG. 13: shows the relative reduction of Alamar Blue dye (normalized to the growth control (=100%)) by human keratinocytes grown on PZI, SMAMP and PSB for 24, 48 and 72 h, respectively.

### EXAMPLES

The examples shown in the following are merely illustrative and shall describe the present invention in a further way. These examples shall not be construed to limit the present invention thereto.

The herein presented data shows that the inventive antimicrobial and antifouling polymers and accordingly obtained polyzwitterion (PZI) coated surfaces (networks and monolayers) are strongly antimicrobial against both S. aureus and E. coli (as representatives of Gram-positive and Gram-negative bacteria, respectively). Even compared to the strongly antimicrobial SMAMP surface, PZI killed S. aureus more quantitatively, and the PZI biofilm mass was also significantly less on PZI than on SMAMP, because the debris of the dead bacteria cannot adhere as firmly to the PZI surface as it can stick to the SMAMP surface. Likewise, the data shows that PZI was strongly antimicrobial, protein-repellent and strongly reduced biofilm formation, while PSB was only protein-repellent and reduced biofilm formation less than the PZI. Hence, a superior antimicrobial and simultaneous antifouling property could be detected for the PZIs described herein. The instant invention thus presents the first polyzwitterions that are simultaneously antimicrobial and protein-repellent, and therefore significantly reduce bacterial biofilm formation. These represent highly promising material for medical applications.

### Experimental Data

### Example 1

### General:

All chemicals were obtained as reagent grade from Sigma-Aldrich or Carl Roth and used as received. Dichloromethane was distilled from CaH₂ under nitrogen. Solvents for gel-permeation chromatography (GPC) were HPLC quality and obtained from Carl Roth. Gel permeation chromatography (chloroform or THF, calibrated with PMMA standards) was measured on a PSS SDV or PSS GRAM column (PSS, Mainz, Germany). NMR spectra were recorded on a Bruker 250 MHz spectrometer (Bruker, Madison, Wis., USA). Electron ionization mass spectra were measured on a Thermo TSQ 700 spectrometer (Thermo Scientific, ionization energy 70 eV, source temperature 150° C.). Optical and fluorescence microscopy images were taken on a Nikon Eclipse Ti-S inverted microscope (Nikon GmbH, Düsseldorf, Germany).

### Synthesis:

### Synthesis of Crosslinking Agents:

The crosslinking agent 3EBP-silane was synthesized as described in the literature (see M. Gianneli, R. F. Roskamp, U. Jonas, B. Loppinet, G. Fytas, W. Knoll, Soft Matter 2008, 4, 1443). The crosslinking agent LS-BP was synthesized using the following procedure (Scheme 1):

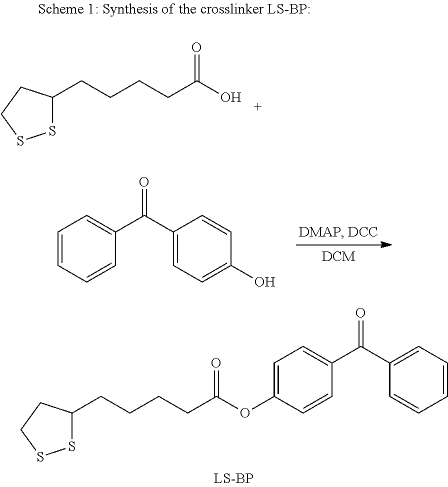 [SMILES: O=C(O)CCCCC1CCSS1 ; O=C(c1ccccc1)c1ccc(O)cc1 ; O=C(CCCCC1CCSS1)Oc1ccc(C(=O)c2ccccc2)cc1]

A solution of 4-hydroxybenzophenone (2.0 g, 10 mmol), lipoic acid (2.3 g, 11 mmol, 1.1 aq.) and DMAP (1.3 g, 11 mmol, 1.1 aq.) in anhydrous dichloromethane (DCM) was cooled by using an ice bath. Dicyclohexyl carbodiimide (DCC) (2.3 g, 11 mmol, 1.1 aq.) was dissolved in 10 ml anhydrous DCM and added within one hour. After stirring for 24 h at room temperature, the resulting urea byproduct was removed by filtration over a short silica gel column. The solvent was evaporated, and the crude product was purified by column chromatography (silica gel, ethyl acetate/n-hexane 1:3). The product 11 (2.4 g, 6.2 mmol, 62%) was obtained as a yellow solid.

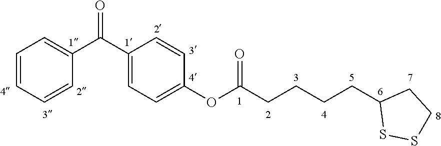 [SMILES: O=C(CCCCC1CCSS1)Oc1ccc(C(=O)c2ccccc2)cc1]

¹H-NMR (250 MHz, CDCl₃): 1.60 (m, 2H, 4-CH₃), 1.72-1.85 (m, 4H, 3-CH₂ & 5-CH₂), 1.93 (dddd, 1H, 7-CH eq.), 2.48 (dddd, 1H, 7-CH ax.), 2.62 (t, 2H, 2-CH₂), 3.14 (m, 2H, 8-CH₂), 3.60 (ddt, 1H, 6-CH), 7.19-7.24 (m, 2H, 3″-CH & 5″-CH), 7.46-7.51 (m, 2H, 3′-CH & 5′-CH), 7.56-7.62 (m, 1H, 4″-CH), 7.78-7.82 (m, 2H, 2″-CH & 6″-CH), 7.83-7.88 (m, 2H, 2′-CH & 6′-CH). ¹³C-NMR (62.9 MHz, CDCl₃): 25.0 (2-CH₂), 29.1 (4-CH₂), 34.6 (2-CH₂), 35.0 (5CH₂), 38.9 (8-CH₂), 40.7 (7-CH₂), 56.7 (6-CH), 121.9 (3″-CH), 128.8 (2″-CH), 130.4 (3′-CH), 132.1 (2′-CH), 132.9 (4″-CH), 135.4 (1″-C), 137.9 (f-C), 154.3 (4′-C—O), 171.9 (1-C═O), 195.9 (O═CPh₂).

The compounds were used for surface attachment of the herein described PZI network structures and polymers.

### Synthesis of Zwitterion Precursor Monomer:

The zwitterion precursor monomer was obtained from exo-7-oxabicyclo[2.2.1]hept-5-ene-2,3-dicarboxylic acid anhydride (5 g, 30.0 mmol), which was dissolved in CH₂Cl₂. 1.1 eq of N-(tert-butoxycarbonyl)ethanolamine (5.32 g, 33 mmol) and 10 mol % 4-dimethylaminopyridine (DMAP) were added. After stirring over night, the solution was washed with 10% KHSO₄ and water, and dried with Na₂SO₄. The solvent was removed by evaporation under reduced pressure and the product was dried under high vacuum. A white solid was obtained. The isolated yield was 70%.

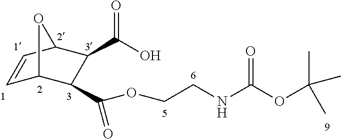 [SMILES: CC(C)(C)OC(=O)NCCOC(=O)[C@H]1C2C=CC(O2)[C@H]1C(=O)O]

¹H-NMR (250 MHz, CDCl₃): 1.46 (s, 9H, 9-CH₃), 2.87 (m, 2H, 3-CH & 3′-CH), 3.38 (m, 2H, 6-CH₂), 4.03-4.31 (m, 2H, 5′-CH₂), 5.13 (br s, 1H, NH), 5.26 & 5.34 (m, 2H, 2-CH & 2′-CH), 6.47 (m, 2H, 1-CH & 1′-CH), 6.81-7.02 (br s, 1H, OH).

¹³C-NMR (62.9 MHz, CDCl₃): 28.35 (C9), 39.60 (C6), 46.78 & 47.35 (C3, C3′), 64.44 (C5), 80.08 & 80.52 (C2, C2′), 136.41 & 136.58 (C1, C1′), 171.44 & 174.59 (C4, C4′).

MS: m/z=328.14 (M⁺.), 283.09 (M-COOH), 272.07 (M-tBu), 226.03 (M-CO₂tBu).

### Polymerization of Zwitterion Precursor Monomer:

The polymerization of the zwitterion precursor monomer was performed under nitrogen using standard Schlenk techniques. The zwitterion monomer precursor (500 mg, 1.2 mmol) was dissolved in 5 mL THF. The Grubbs third generation catalyst (3.7 mg, 5 μmol) was dissolved in 2 mL CH₂Cl₂ and added in one shot to the vigorously stirring monomer solution at room temperature. After 30 min, the living polymer chain was end-capped with an excess of ethylvinyl ether (1 mL, 750 mg, 10 mmol). The solution was allowed to stir for 1 or 2 hours. The solvent was then evaporated under reduced pressure. The product was re-dissolved in a small amount of ethyl acetate and added dropwise into ice-cooled n-hexane. The colorless precipitate was removed by filtration, and dried in dynamic vacuum. GPC was performed in THF (calibrated with PMMA standards).

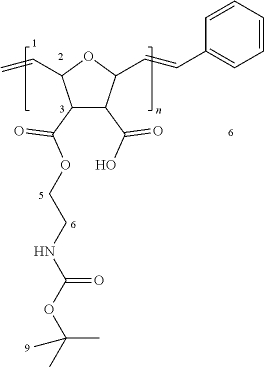

GPC: Mₙ=73,000 g/mol, M_{w}=iii 200 g mol⁻¹, PDI=1.5

¹H-NMR 250 MHz, THF-d₈): 1.41 (s, 9H, H9), 3.10 (br m, 2H, H3 & H3′), 3.28 (br m, 2H, H6), 4.08 (br m, 2H, H5), 4.67 (m, 1H, H2 trans), 5.10 (br s, 1H, H2 cis), 5.59 (br s, 1H, NH), 5.88 (br m, 1H, H1 cis) and 6.08 (br m, 1H, H1 trans).

¹³C-NMR (75 MHz, THF-d₈): ¹³C-NMR (62.9 MHz, THF-d₈): 28.93 (C9), 40.37 (C6), 53.83 & 54.40 (C3, C3′), 64.98 (C5), 78.93 (BOC—C—CH₃), 81.44 & 81.88 (C2, C2′), 133.42 & 133.60 (C1, C1′), 156.86 (N—C═O) 171.36 & 172.72 (C4, C4′).

### Polyzwitterion Precursor Polymer Deprotection:

The N-Boc protected zwitterionic polymer (500 mg) was dissolved in 20 mL of dry THF under nitrogen. To this solution, 20 mL of 4 M HCl in dioxane was added. After a few minutes, 5-10 vol % dry methanol were added to maintain solubility of the hydrolyzing polymer. The mixture was stirred for 18 hours at room temperature. The solvent was removed and the precipitate was re-dissolved in methanol. It was purified by precipitation into ice-cooled diethyl ether. Up to 10 vol % n-hexanes were added in case the polymer did not precipitate.

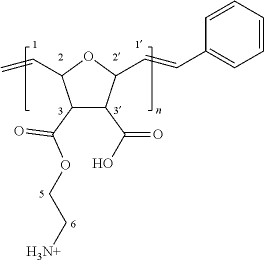

¹H-NMR (250 MHz, MeOH-d₄): 3.35 (br s, 2H, H3 & H3′+solvent), 3.72 (br s, 2H, H6), 4.40 (br s, 2H, H5), 4.74 (m, 1H, H2 trans+solvent), 5.16 (br s, 1H, H2 cis), 5.73 (br s, 1H, H1 cis) and 5.97 (br s, 1H, H1 trans).

¹³C-NMR (62.9 MHz, MeOH-d₄): 40.10 (C6), 53.42 & 53.99 (C3, C3′), 62.76 (C5), 78.63 & 82.43 (C2, C2′), 132.66 & 133.65 (C1, C1′), 173.06 & 172.28 (C4, C4′).

### Synthesis of Butyl SMAMP Monomer:

The Butyl monomer was synthesized and characterized as previously published (see K. Lienkamp, A. E. Madkour, A. Musante, C. F. Nelson, K. Nuesslein, N. Tew Gregory, J Am Chem Soc 2008, 130, 9836).

### Polymerization of Butyl SMAMP Monomer:

The polymerization of the Butyl SMAMP monomer was performed under nitrogen using standard Schlenk techniques. The Butyl monomer (500 mg, 1.42 mmol) was dissolved in 3 mL CH₂Cl₂. Grubbs third generation catalyst (0.72 mg, 1.1 μmol) was dissolved in 1 mL CH₂Cl₂ in a second flask and added in one shot to the vigorously stirring monomer solution at room temperature under N₂. After 30 min, excess ethylvinyl ether (1 mL, 750 mg, 10 mmol) was added. The mixture was stirred for 2 hours. The solvent was then evaporated under reduced pressure. The product was re-dissolved in a small amount of dichloromethane and added dropwise into ice-cooled n-hexane. The colorless precipitate was removed by filtration, and dried in dynamic vacuum. The NMR signals of the polymer matched those in the literature (see K. Lienkamp, A. E. Madkour, A. Musante, C. F. Nelson, K. Nüsslein, G. N. Tew, Journal of the American Chemical Society 2008, 130, 9836).

GPC analysis (PSS SDV column, Chloroform, r.t., 1 mL min⁻¹): Mₙ=235,900 g mol⁻¹, M_{w}=260,100 g mol⁻¹, PDI=1.1.

### Synthesis of PSB Monomer:

The PSB monomer was synthesized and characterized as previously published (see S. Colak, G. N. Tew, Langmuir 2012, 28, 666).

### Polymerization of PSB Monomer:

The polymerization of the PSB monomer was performed under nitrogen using standard Schlenk techniques.

### Synthesis of the Benzophenone-Containing Monomer for the Internal Crosslinker (N-(2-(4-oxobenzophenone)-ethyl)-3,6-tetrahydrophthalimide)

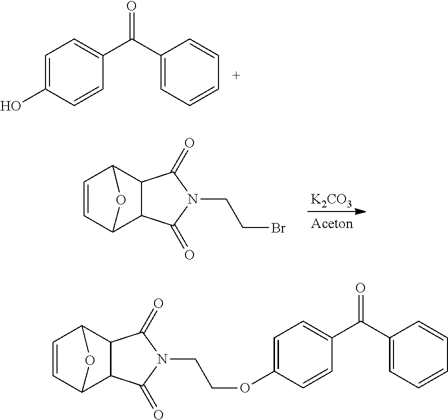

4-Hydroxybenzophenone (19.88 g, 0.1 mol, 10 eq) and K₂CO₃ (13.82 g, 0.1 mol, 10 eq) were dissolved in 250 mL dry acetone and the reaction mixture was heated to the boiling temperature. Then N-(2-bromoethyl)-3,6-tetrahydrophthalimide (2.72 g, 0.01 mol, 1 eq) was slowly added. The reaction mixture was refluxed for 24 h. After cooling down, water was added and the solution was extracted with DCM. The combined organic phases were washed with 10% NaOH (3×). The organic phase was dried and the solvent was evaporated under reduced pressure. After removal of the solvent, the residue was not solid. NMR was taken and the oil was recrystallized via dissolving the residue in small amounts of DCM and layering with hexane. The flask was stored in freezer until crystallization occurred. The product was filtered off, washed with cold hexanes, and dried.

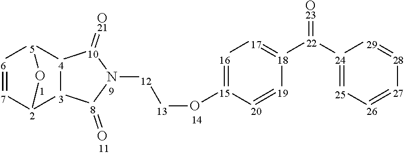

¹H NMR (250 MHz, acetone): 7.44-7.89 (m, 7H), 7.04 (d, J=8.85 Hz, 2H), 6.58 (s, 2H), 5.16 (s, 2H), 4.25 (t, J=5.84 Hz, 2H), 3.88 (t, J=5.80 Hz, 2H), 2.96 (s, 2H)

¹³C NMR (62.86 MHz, acetone): 195.3 (1C), 177.1 (1C), 163.1 (1C), 139.3 (1C), 137.5 (2C), 133.1 (2C), 132.8 (1C), 131.4 (1C), 130.3 (2C), 129.2 (2C), 115.2 (2C), 81.9 (1C), 65.2 (1C), 48.4 (2C), 38.4 (1C)

### Synthesis of the Internal Crosslinker by Copolymerization of (N-(2-(4-oxobenzophenone)-ethyl)-3,6-tetrahydrophthalimide) with the Inventive Monomers

A stock solution of Grubbs' catalyst was prepared in a flame dried flask. The benzophenone monomer (295 mg, 0.9 mmol, 0.9 eq) and the zwitterion monomer (39 mg, 0.1 mmol, 0.1 eq) were added to a flame dried flask and dissolved in 10 mL anhydrous THF under nitrogen atmosphere. After 30 min of stirring, 2 mL of the stock solution (c=2.4 mg/mL) was added in one shot. The reaction mixture was stirred for another 60 minutes. Then 1 mL of ethyl vinyl ether was added to terminate the reaction. After another 30 minutes the polymer was precipitated in diethylether. The polymer was dried under high vacuum overnight. NMR showed traces of diethyl ether. Therefore the product was further dried.

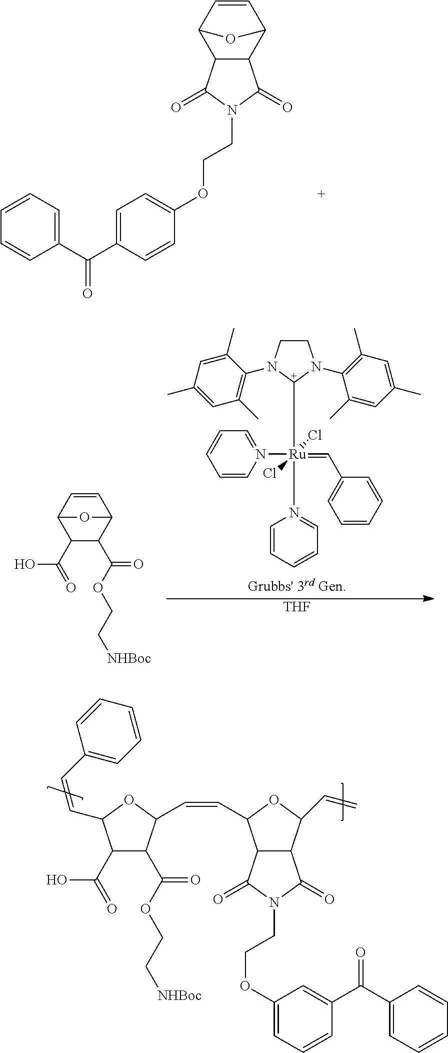

¹H NMR (250 MHz, THF): 7.31-7.87 (m, 7H, benzophenone), 6.93-7.10 (m, 2H, benzophenone), 50.85-6.20 (trans) and 5.59 (cis) (br, 2H total), 50.10 (cis) and 4.67 (trans) (br, 2H total), 4.18-4.40 (m, 2H, bBenzophenone), 4.07 (br, 2H), 3.79-3.97 (m, 2H, benzophenone), 3.28 (br, 2H), 3.11 (br, 2H), 1.41 (s, 9H)

### Derivatization for GPC Measurement:

20 mg of the internal crosslinker polymer were dissolved in 1 mL THF (anh.) and 1 mL MeOH (anh.). Then 2 mL of trimethylsilyl diazomethane (2M in diethylether) were added. After 30 minutes the solution was evaporated and the remaining polymer was used for GPC analysis.

GPC analysis (PSS SDV column, Chloroform, r.t., 1 mL min⁻¹): Mₙ=38,000 g mol⁻¹, M_{w}=46,000 g mol⁻¹, PDI=1.2.

Functionalization of Silicon Wafer and Gold Substrate with Crosslinking Agents:

Silicon wafer: A solution of 3EBP-silane (20 mg mL⁻¹ in toluene) was spin coated on a 525±25 μm thick, one-side-polished 100 mm standard Si (CZ) wafer ([100] orientation) at 1000 rpm for 120 s. The wafer was cured for 30 min at 120° C. on a preheated hot plate, washed with toluene and dried under a continuous nitrogen flow.

### Gold:

For SPR measurements, the LaSFN9 glass slides coated with a 1 nm chromium layer and a 50 nm gold layer were covered with a 5 mM solution of LS-BP in toluene for 24 h. Then the samples were washed with toluene and ethanol, and dried under nitrogen flow. SPR measurements indicated that the thickness of the LS-BP layer was 1 nm.

Wound dressing: Commercially available polyurethane-based wound dressing foam (Suprasorb P, Lohmann and Rauscher, Rengsdorf, Germany, 5 mm thickness) was cut into 2×2 cm pieces, which were immersed into a 5 mM solution of LS-BP in toluene for 24 h. Then, the samples were washed with toluene and ethanol, and dried under nitrogen flow (see also FIG. 2).

Immobilization of the Inventive PZI Polymer (and the Reference Polymers) as Surface-Attached Polymer Network on Silicon Wafers, Gold and Glass Substrates that have been Functionalized with a “Molecule for Surface Attachment” Containing the “Photo-Crosslinking Unit” Benzophenone, Using the “External Crosslinker” Pentaerythritol-Tetrakis-(3-Mercaptopropionate) Carrying Thiols as “Photo-Crosslinking Units”:

### Procedure Using the Protected PZI:

A stock solution (Solution A) was prepared by dissolving pentaerythritol-tetrakis-(3-mercaptopropionate) mL, 1.3 g, 2.6 mmol) in THF (50 mL). The poly(zwitterion) precursor (10 mg, 0.027 mmol) was dissolved in Solution A (0.25 mL). Chloroform (0.4 mL for silicon coating or 0.8 mL for gold and glass coating) was added as co-solvent. The mixture was stirred for 60 s. From this solution, a polymer film was spin cast on a 3-EBP treated silicon wafer or LS-BP treated gold substrate at 3000 rpm for 30 sec. The film was crosslinked at 254 nm for 30 min in a BIO-LINK Box (Vilber Lourmat GmbH). It was then washed with THF to remove unattached polymer chains and dried overnight under N₂-flow. This yielded the precursor poly(zwitterion) network. To remove the Boc protective groups, function, the film was immersed in HCl (4 M in dioxane) for 12 hours and washed twice with ethanol. It was then dried over night under N₂-flow to yield the PZI network.

Procedure for Direct Coating with Deprotected PZI:

A stock solution of crosslinker was prepared by dissolving pentaerythritol-tetrakis-(3-mercaptopropionate) (0.1 mL, 0.13 g, 0.26 mmol) in ethyl acetate (5 mL). The deprotected PZI was dissolved in 0.8 mL methanol. Then 0.2 mL crosslinker solution in ethyl acetate was added and the mixture was stirred for 60 s. From this solution, a polymer film was spin cast direct on a silicon wafer at 3000 rpm for 30 s. The film was crosslinked at 254 nm for 30 min in a BIO-LINK Box (Vilber Lourmat GmbH). It was then washed with methanol to remove unattached polymer chains and dried under N₂-flow.

### Butyl SMAMP Network:

A stock solution (Solution B) was prepared by dissolving pentaerythritol-tetrakis-(3-mercaptopropionate) (1 mL, 1.3 g, 2.6 mmol) in CH₂CL₂ (50 mL). The precursor Butyl SMAMP polymer (10 mg, obtained as described in P. Zou, D. Laird, E. K. Riga, Z. Deng, H.-R. Perez-Hernandez, D. L. Guevara-Solarte, T. Steinberg, A. Al-Ahmad, K. Lienkamp, Journal of Materials Chemistry B 2015, 3, 6224-6238) was dissolved in Solution B (0.25 mL). Toluene (0.3 mL) was added as co-solvent, and the mixture was stirred for 60 s. The remaining steps were exactly the same as described above for the poly(zwitterion) network.

### PSB Network:

A stock solution (Solution C) was prepared by dissolving pentaerythritol-tetrakis-(3-mercaptopropionate) (0.1 mL, 0.13 g, 0.26 mmol) in 2,2,2-trifluoroethanol TFE (5 mL). The PSB polymer (30 mg, obtained as described in S. Colak, G. N. Tew, Langmuir 2012, 28, 666-675) was dissolved in Solution C (0.25 mL). TFE (0.8 mL) was added to adjust the desired coating thickness. The mixture was stirred for 60 s. The solution was spin coated on a 3-EBP treated silicon wafer at 3000 rpm for 10 s. The film was crosslinked at 254 nm for 30 min in a BIO-LINK Box (Vilber Lourmat GmbH). It was then washed with TFE to remove unattached polymer chains and dried under N₂-flow.

Immobilization of the Inventive PZI Polymer as Surface-Attached Polymer Network on Silicon Wafers, Gold and Glass Substrates that have been Functionalized with a “Molecule for Surface Attachment” Containing the “Photo-Crosslinking Unit” Benzophenone, Using the “Internal Crosslinker” Containing (N-(2-(4-Oxobenzophenone)-Ethyl)-3,6-Tetrahydrophthalimide)) Carrying Benzophenone as “Photo-Crosslinking Units”:

10 mg of the “internal crosslinker” containing N-(2-(4-oxobenzophenone)-ethyl)-3,6-tetrahydrophthalimide were dissolved in 1 mL of THF. The solution was spin coated on a 3-EBP treated silicon wafer at 3000 rpm for 30 s. The film was crosslinked at 254 nm with 3 J/cm². in a BIO-LINK Box (Vilber Lourmat GmbH). The film thickness d was determined by ellipsometry.

d=58±5 nm

### Polymer Network Characterization:

### Ellipsometry:

The thickness of the dry polymer layers on silicon wafers was measured with the auto-nulling imaging ellipsometer Nanofilm EP³ (Nanofilm Technologie GmbH, Göttingen, Germany), which was equipped with a 532 nm solid-state laser. A refractive index of 1.5 was used for all measurements. For each sample, the average value from three different positions was taken.

PZI network: 86±1 nm

Butyl SMAMP network: 152 nm±1 nm

PSB network: 71 nm±3 nm

### Attenuated Total Reflection Fourier Transform Infrared Spectroscopy (ATR-FTIR):

Double side polished silicon wafers were used as substrates for the FTIR experiments. The polymer layer was immobilized on one side of a double side polished silicon wafer. The spectra were recorded from 4000 to 400 cm⁻¹ with a Bio-Rad Excalibur spectrometer (Bio-Rad, München, Germany), using a spectrum of the blank double side polished silicon wafer as background. Spectra of the different test samples are shown in FIGS. 6a), b) and c).

### Atomic Force Microscopy (AFM):

The topography of the surfaces was imaged with a Dimension FastScan and Icon from Bruker. Commercial FastScan-A cantilevers (length: 27 μm; width: 33 μm; spring constant: 18 Nm⁻¹; resonance frequency: 1400 kHz) and ScanAsyst Air cantilevers (length: 115 μm; width: 25 μm; spring constant: 0.4 Nm⁻¹; resonance frequency: 70 kHz) were used. All AFM images were recorded in tapping mode in air and ScanAsyst in air, respectively. The obtained images were analyzed and processed with the software ‘Nanoscope Analysis 9.1’. For each sample, the root mean square (RMS) average roughness R from three images of an area of 5×5 μm² at different positions was taken. The images are shown in FIG. 7.

### Contact Angle:

The contact angle system OCA 20 (Dataphysics GmbH, Filderstadt, Germany) was used to measure the static, advancing and receding contact angles of the SMAMP precursors and the activated SMAMP networks. The average value of the contact angle was obtained from four measurements on different positions of one sample. The static contact angles were calculated with the Laplace-Young method, while the advancing and receding contact angles were calculated with elliptical and tangent methods.

| | Static/° | Advancing/° | Receding/° |
|---|---|---|---|
| PZI network | 21 ± 2 | 37 ± 1 | 14 ± 1 |
| Butyl SMAMP network | 70 ± 3 | 68 ± 3 | 17 ± 2 |
| PSB network | 37 ± 2 | 56 ± 2 | 22 ± 2 |

### Zeta Potential Measurements:

The streaming current measurements for electrokinetic surface characterization were performed with an electrokinetic analyzer with integrated titration unit (SurPASS, Anton Paar GmbH, Austria). The analyzer was equipped with an adjustable gap cell. Ag/AgCl electrodes were used to detect the streaming current. The respective polymers were spin-cast on fused silica substrates (MaTeC, 20×10×1 mm lp, Ch.Nr. 13112704) and put into the measuring cell.

Before each measurement the electrolyte hoses were rinsed with ultrapure water until a conductivity of <0.06 mS m⁻¹ was reached. The measuring cell was mounted and the electrolyte solution (1 mM KCl) was prepared. The pH of the electrolyte solution was adjusted to pH 3.5 with 0.1 M HCL prior to filling the electrolyte hoses. The gap height was adjusted to approx. 105 μm while the system was rinsed for 180 sec. at 300 mbar.

Titration measurement was performed with 0.1 M NaOH. The target pressure of the pressure ramp was set to 400 mbar. After titration and before each measurement cycle the system was rinsed for 180 sec. at 300 mbar. The pressure program was: target pressure 400 mbar; max. time 20 s; current measurement; 2 repetitions. The rinse program was: max. pressure 300 mbar; max. time 180 s. The parameters for the pH titration were: pH difference=0.2; volume increment 0.01 mL; pH minimum 2.5; pH maximum 10.5.

### SPR (Surface Plasmon Resonance) Measurements and Sample Preparation.

SPR measurements were performed on a RT2005 RES-TEC device in Kretschmann configuration from Res-Tec, Framersheim, Germany. Excitation was done with a He—Ne-Laser with λ=632.8 nm. SPR substrates were homemade (LaSFN9 glass from Hellma GmbH, Müllheim, Germany; coated with 1 nm Cr and 50 nm Au at the Clean Room Service-Center (RSC) of the Department of Microsystems Engineering, University of Freiburg, using the device CS 730 S, Von Ardenne, Dresden, Germany). (see FIG. 8).

### SPR Angular Scans.

To study the build-up of the material, a full reflectivity curve was measured after each fabrication step. Before and after the adsorption experiments in the kinetics mode, full angular scans of the dry substrates were also measured.

### SPR Kinetics Experiments.

Protein adsorption was studied in the kinetics mode. To set up the experiment, an angular scan of the substrate under HEPES flow was performed to detect the minimum. The protein adsorption experiments in the kinetic mode were then carried out at θₑₓₚ=θₘᵢₙ−1 and a flow rate of 50 μl h⁻¹ of the fibrinogen solution (1 mg ml⁻¹). To determine the thickness of adsorbed fibrinogen after the kinetics experiment, the surfaces were rinsed with MilliQ water for 15 min to remove residual salt and dried under nitrogen flow. Afterwards a reflectivity curve was measured again. The thickness of each protein layer was calculated by simulations based on the Fresnel equations, which were performed with the software ‘Winspall’ (see FIG. 10).

### PZI Network:

The following permittivities ε′ and ε″ were used: LaSFN9 (ε′=3.4036; ε″=0); Cr (ε′=−6.3; ε″=20); Au (ε′=−12.3; ε″=1.16) PZI (ε′=2.43; ε″=0), LS-BP, fibrinogen (ε′=2.25; ε″=0), nitrogen (ε′=1; ε″=0).

### Poly(Sulfobetaine) (PSB) Network:

The following permittivities ε′ and ε″ were used: LaSFN9 (ε′=3.4036; ε″=0); Cr (ε′=−6.3; ε″=20); Au (ε′=−12; ε″=1.3) PSB (ε′=2.25; ε″=o), LS-BP, fibrinogen (ε′=2.25; ε″=0), nitrogen (ε′=1; ε″=0).

### Determination of the Swelling Ratio of Surface Attached Polymer Networks

For the swelling experiments, thicker samples (about 250 to 2000 nm) were used, which would not only give rise to a plasmon peak in the reflectivity vs. angle curve, but also to waveguide peaks. This allows for more precise data fitting. In each swelling experiment, the SPR reflectivity curve of dry polymer network was recorded first. Then, solvent was injected into the flow cell, and after equilibration for at least 30 minutes, the SPR reflectivity curve of the swollen material was recorded. Each curve was simulated with Fresnel calculations and the two unknown parameters, the sample thickness d and the real part of the permittivity (ε′) of the polymer network, were obtained by fitting the calculated curve to match the minimum of the wave guide modes. The swelling ratio of the polymer network was calculated by:

$$Q = \frac{{d}_{solvent}}{{d}_{dry}}$$

The SPR reflectivity curves (grey) are shown together with the simulation curves (black dashed) for each polymer layer. The respective layer thickness and real permittivity are listed below the curves.

The physical characterization of the exemplary surface-attached PZI network 6 is displayed in table 1. The dry layer thickness and the swellability ratio (=water−swollen layer thickness/dry layer thickness) were obtained by ellipsometry measurements; the fibrinogen adhesion was quantified using surface plasmon resonance spectroscopy; the isoelectric point was determined using the SurPass surface analyzer (Anton Paar, Austria). The data shows that the PZI-coated surface 6 was strongly protein-repellent.

TABLE 1

| | Diy Layer | Swellability | Fibrinogen | Iso-electric |
|---|---|---|---|---|
| | Thickness/nm | Ratio/H₂O | adhesion/ng mm⁻² | point |
| PZI | 86 ± 1 | 1.9 | 0 ± 0 | 6.6 ± 0.1 |

### Polymer Network Characterization:

### Antimicrobial Activity Assay.

The experiments were performed using a modification of the Japanese Industrial Standard JIS Z 2801:2000 ‘Antibacterial Products Test for Anti-bacterial Activity and Efficacy’ as reported previously (see a) A. Al-Ahmad, P. Zou, D. L. Guevara Solarte, E. Hellwig, T. Steinberg, K. Lienkamp, PLoS One 2014, 9, e111357/1; b) J. Haldar, A. K. Weight, A. M. Klibanov, Nature Protocols 2007, 2, 2412). S. aureus (ATCC29523) and E. coli (ATCC25922) were cultured overnight in triptic soy broth and diluted 1:10. Optical density was checked 3-4 hours later and the bacterial culture (1.5 ml of S. aureus and 150 μL of E. coli) was mixed in a chromatography sprayer bottle with 100 ml of sterile NaCl 0.9% solution and continuously stirred (see a) A. Al-Ahmad, P. Zou, D. L. Guevara Solarte, E. Hellwig, T. Steinberg, K. Lienkamp, PLoS One 2014, 9, e111357/1). The test samples (5 of each material), including positive and negative controls, were fixed at the center of sterile Petri dishes each and placed at a distance of 15 cm to the spray nozzle. Then the bacterial suspension was sprayed onto the samples using compressed air from a 50 mL syringe (see P. Zou, D. Laird, E. K. Riga, Z. Deng, F. Dorner, H.-R. Perez-Hernandez, D. L. Guevara-Solarte, T. Steinberg, A. Al-Ahmad, K. Lienkamp, Journal of Materials Chemistry B 2015, 3, 6224). Afterwards, the petri dishes were immediately covered and incubated for 2 h in a humid chamber at 37° C. under aerobic conditions and 5% CO₂. 50 μL of sterile 0.9% NaCl solution was added onto the samples and left for 2 min. To ensure removal of bacteria from the surface the solution was pumped back and re-pipetted twice and spread over Columbia blood agar plates. These were incubated overnight at 37° C. without agitation. CFUs were counted with the software ‘Quantitiy One’ Each experiment was tested at least twice.

### Biofilm Formation Studies

The test samples were silicon wafer pieces coated with the different polymer networks cut to a size of 5×5 mm. The growth control was an uncoated silicon wafer piece cut to a size of 5×5 mm. The samples and control pieces were placed in the wells of a sterile 24-wellplate using sterilized tweezers. 1000 μL of bacterial overnight culture (106 bacteria cm-3) in tryptic soy broth (TSB) medium was added to each well. The bacteria tested in each experiment were: S. aureus ATCC29523, E. coli (ATCC25922).

All the samples sets were incubated (at 37° C. with 5% CO₂) without agitation for 2 h, then 500 μL of TSB (enriched with sucrose) was added to each well, and incubated for different times (12 h, 24 h, 48 h, 72 h) under these conditions. After these incubation times, the samples and the growth control were placed in a new microplate and all of them were washed 3 times with NaCl (0.9%) in order to remove the non-adherent microorganisms.

Life/dead staining (Live/Dead BacLight bacterial viability kit, Molecular Probes, Eugene, Oreg., USA) was used according to the instructions of the manufacturer in each well, and the samples were stored for 10 min in a dark chamber; after that every sample was placed face down in an Ibidi μ-Slide 8 well chamber, and imaged using the Fluorescent microscope (Zeiss Axio Observer Z1) with a 63× objective. The excitation/emission maxima for these dyes were 500 nm for SYTO® 9 (green-fluorescent) stain and 617 nm for propidium iodide (red-fluorescent) stain.

Results of the biofilm formation are shown in FIG. 11 (top and bottom). As can be seen in FIG. 11, top, PZI significantly inhibited biofilm formation in the presence of S. aureus (see FIG. 11 biofilm formation of S. aureus on PZI, SMAMP (=Butyl) and PSB (compared to the negative control (=growth control) after 12, 24, 48 and 72 h. The images are overlay of the green fluorescence and the red fluorescence. Moreover, as can be seen in FIG. 11 bottom, biofilm formation was significantly inhibited in the presence of E. coli on PZI, SMAMP (=Butyl) and PSB (compared to the negative control (=growth control) after 12, 24, 48 and 72 h. The images are an overlay of the green fluorescence and the red fluorescence.

### Alamar Blue Assay.

### Sample Preparation:

Alamar Blue experiments were performed on round glass microscope coverslips (22 mm diameter, thickness 0.5 mm; Langenbrick, Emmendingen, Germany), which had been coated with the test networks as described above. Coverslips without coating were used as controls. Before starting the experiment, coverslips used as controls were washed 30 minutes in 100% isopropyl alcohol to emulate the process used for the spin-coated samples. Thereafter, both control and sample coverslips were sterilized for 15 minutes in 70% ethanol. All coverslips (test samples and controls) were subsequently washed 3 times with PBS in order to remove residual ethanol. Coverslips (samples and controls) were tested in triplicate and placed in 12-well plates (bio-one Cellstar, Greiner, Frickenhausen, Germany).

### Cell Treatment:

Immortalised HPV-16 gingival mucosal keratinocyte (GM-K) cells [7] were cultivated in Keratinocyte Growth Medium (KGM) (Promocell, Heidelberg, Germany) with accompanying supplements prepared at concentrations supplied by the manufacturer: bovine pituitary extract—0.004 ml/ml; epidermal growth factor (EGF)—0.125 ng mL⁻¹; insulin—5 μg mL⁻¹; hydrocortisone—0.33 μg mL⁻¹; epinephrine—0.39 μg mL⁻¹; transferrin—10 μg mL⁻¹; CaCl₂—0.06 mM; in addition to the antibiotic kanamycin at 100 μg mL⁻¹. Cells were trypsinized at between 70-90 confluency and resuspended in supplement/antibiotic free KGM. They were then seeded out onto test and control surfaces in 1 mL medium at 1.5×10⁵ cells mL⁻¹ in supplement/antibiotic free medium. Thereafter, the 12 well plates containing the cells were incubated at 37°/5% CO₂ for 5 hours allowing cells to settle and begin adhesion. At this time 500 μL of medium above the cells was carefully aspirated and replaced by 500 μl medium containing double normal supplement concentration yielding a normal supplement concentration medium. Cells on test surfaces and controls were cultivated for a further 18 hours (total 24 hours), 42 h (total 48 h) and 66 h (total 72 h). At each time point positive control samples were generated by aspirating 500 μL medium from 3 wells and adding 500 μL 60% iso-propyl alcohol to give a 30% iso-propyl alcohol solution. A negative control was generated by removing the old medium and replacing it with 1 mL fresh medium. All samples and controls were cultivated for a further 30 minutes, after which 110 μL pre-warmed (37° C.) Alamar Blue (AbD Serotec, Oxford, UK) was slowly pipetted into each well (samples and controls) with gentle agitation to ensure homogeneous dispersion giving a 10% solution. Cells were returned to the incubation chamber for 2 hours, after which time all medium containing Alamar Blue was aspirated and collected into 1.5 ml Eppendorf tubes. Tubes were centrifuged at 1,000 g for 5 minutes to exclude cells, then the fluorescence intensity of the supernatant was measured (excitation at 540 nm and measurement at 590 nm) on a Tecan, Infinte 200 plate reader and data analysed according to the Alamar Blue manufacturer's instructions. The experimental procedure was repeated at 48 hours and 72 hours to give time dependent data.

Results are shown in FIGS. 5, 12 and 13. FIG. 5 shows an Alamar Blue dye reduction (relative to initial dye concentration) by human keratinocytes grown for 24, 48 and 72 h, respectively, on PZI, SMAMP and PSB. The dye reduction by PZI and PSB was comparable to that of the growth control (neg). The dye reduction of the positive control corresponds to no cell growth. FIG. 12 shows optical micrographs (phase contrast) of human keratinocytes grown on an uncoated glass slide (−control, growth control), PSB and PZI after 24 h (A to C), 48 h (A′ to C′) and 72 h (A″ to C″). The cell density and the cell morphology on PSB and PZI is comparable to that on the growth control. Finally, FIG. 13 shows the relative reduction of Alamar Blue dye (normalized to the growth control (=100%)) by human keratinocytes grown on PZI, SMAMP and PSB for 24, 48 and 72 h, respectively.

### Example 2

### Synthesis of Itaconic Acid 4-propyl-amide

Itaconic anhydride (5.0 g, 44.6 mmol) was dissolved in dichloromethane (DCM) (20 mL) and H₂SO₄ (conc., 0.1 mL) was added. The solution was ice cooled for 15 min. Then the n-propylamine (4.0 mL, 2.9 g, 49.1 mmol, 1.1 eq) in DCM (10 mL) was added dropwise over 30 min. After another 10 min the ice bath was removed and the solution was stirred overnight at room temperature. Subsequently the precipitate (pure product) was removed by filtration and dried at dynamic vacuum overnight. The product was obtained as colorless solid. The structure of the obtained monomer and the proton numbering for ¹H-NMR assignment are shown below.

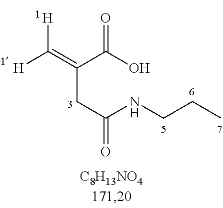

Yield: 3.9 g; 22.8 mmol; 50%

MS (ESI, 4-5 kV): m/z={[M+Na]}=194.08

¹H NMR (250 MHz, Acetone-d6): δ=11.46 (br. s, OH), 7.24 (br. s., NH), 6.22 (s, 1-H), 5.73 (s, 1′-H), 3.24 (s, 3-CH₂), 3.17 (td, J=6.50 Hz, 5-CH₂), 1.51 (tq, J=7.30 Hz, 6-CH₂), 0.90 (t, J=7.42 Hz, 7-CH₃).

¹³C NMR (63 MHz, Acetone-d6): δ=170.22 (s, 4-CO), 167.57 (s, 2′-CO), 136.42 (s, 2-C), 127.38 (s, 1-C), 41.18 (s, 5-C), 39.40 (s, 3-C), 22.92 (s, 6-C), 11.13 (s, 7-C).

### Example 3

### Synthesis of Itaconic Acid 1-(N-Boc-aminoethyl)-4-propyldiamide

The reaction was performed under nitrogen atmosphere. N-Boc-ethylenediamine (2.2 g, 14.0 mmol, 1.2 eq) and DMAP g, 1.2 mmol, 0.1 eq) were added to a solution of the itaconic acid 4-propylamide (2.0 g, 11.6 mmol) in DCM (30 mL). The solution was ice cooled for 10 min, then 1-Ethyl-3-(3-dimethylaminopropyl)carbodiimide (EDC) (2.2 g, 14.0 mmol, 1.2 eq) was added to the reaction solution in one portion. The solution was stirred overnight at room temperature. Then the reaction mixture was washed with HCl (1M, 2×50 mL), aqueous NaHCO₃ (saturated, 2×50 mL), aqueous NaCl (saturated, 1×50 mL) and water (1×50 mL).

It was then dried over Na₂SO₄ and the solvent was evaporated at the rotary evaporator. The product was dried at dynamic vacuum overnight to yield a colorless solid.

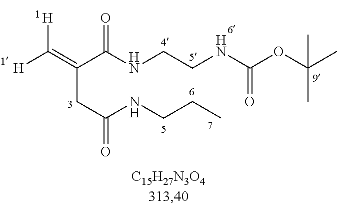 [SMILES: C=C(CC(=O)NCCC)C(=O)NCCNC(=O)OC(C)(C)C]

Yield: 2.21 g, 7.1 mmol, 61%

MS (ESI, 4-5 kV): m/z={[M+Na]⁺}=336.19

¹H NMR (250 MHz, Acetone-d₆) δ=7.89 (br. s., NH), 7.35 (br. s., NH), 6.14 (br. s., NH), 5.84 (s, 1-H), 5.46 (s, 1′-H), 3.36 (td, J=6.10 Hz, 4′-CH₂), 3.26 (t, J=6.10 Hz, 5-CH₂), 3.20 (s, 3-CH₂), 3.14 (td, J=7.00 Hz, 5′-CH₂), 1.50 (tq, J=7.20 Hz, 6-CH₂), 1.42 (s, 9′-(CH₃)₃), 0.90 (t, J=7.42 Hz, 7-CH₃).

¹³C-NMR (63 MHz, Acetone-d₆): δ=170.18 (s, 3′-CO)**, 168.39 (s, 4-CO)**, 156.61 (s, 7′-CO), 134.08 (s, 2-C), 129.32 (s, 1-CH₂), 78.25 (s, 9′-C—(CH₃)₃), 51.93 (s, 5′-CH₂), 48.62 (s, 4′-CH₂), 40.40 (s, 5-CH₂), 34.06 (s, 3-CH₂), 28.13 (s, 9′-C—(CH₃)₃), 22.98 (s, 6-CH₂), 11.15 (s, 7-CH₃).

### Example 4

### Copolymers: Synthesis of Poly[(itaconic acid 1-(N-boc-aminoethyl)₄-propyldiamide)-co-(N,N-dimethyl acrylamide)]

The copolymerization of 1-(2′-N-Boc-ethyl)-4-propyldiitaconamide with N,N-Dimethylacrylamide (DMAA) at the ratio 50 mol % of each comonomer was performed under nitrogen atmosphere. The diitaconamide (to g, 3.2 mmol, 0.5 eq), DMAA (0.3 mL, 0.3 g, 3.2 mmol, 0.5 eq) and AIBN (5.3 mg, 0.003 mmol, 0.1 mol %) were dissolved in N,N-Dimethylformamide (DMF) (1.6 mL). The reaction mixture was subject to three freeze-pump-thaw cycles and then stirred at 70° C. for 22 h. The mixture was then cooled and the reaction was quenched by stirring the open flask under ambient atmosphere. Subsequently the solvent was removed under reduced pressure, the product was diluted in DCM (10 mL) and then added dropwise into n-hexane (100 mL) while stirring vigorously. The polymer precipitated. It was removed by filtration The precipitation was performed three times. The product was obtained as slightly yellow solid and dried at dynamic vacuum overnight. The yield and the GPD data are given below. The structure of the obtained polymers obtained and the proton numbering for ¹H-NMR assignment are shown below.

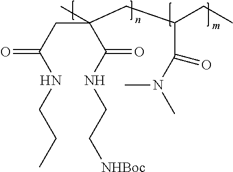

### Poly[(itaconic acid 1-(N-Boc-aminoethyl)₄-propyl diamide)-co-DMAA]

| | Ester to | | | | | |
|---|---|---|---|---|---|---|
| | DMAA | Yield/ | | Mₙ/ | M_{w}/ | |
| Copolymer | ratio | mg | Yield/% | g mol⁻¹ | g mol⁻¹ | PDI |
| Propylamide- | 0.5/0.5 | 495 | 70 | 7,000 | 34,500 | 3.0 |
| co-DMAA | | | | | | |

¹H NMR Propylamide-co-DMAA (250 MHz, CDCl₃): δ 3.56-2.71 (m, 12H), 2.06 (br.s, 2H) 1.67-1.26 (m, 11H), 0.94 (br.s, 3H).

### Example 5

### Synthesis of Itaconic Acid 4-(N-Boc-aminoethyl)-amide

Itaconic anhydride (1.0 g, 8.9 mmol) was dissolved in DCM (30 mL) and ice cooled for 15 min. Then the N-Bocethylenediamine (1.6 g, 9.8 mmol, 1.1 eq) in DCM (10 mL) was added dropwise over 20 min. After another 10 min the ice bath was removed and the solution stirred for 1 h at room temperature. Subsequently the precipitate (pure product) was removed by filtration and dried at dynamic vacuum overnight. The product was obtained as colorless solid. The structure of the obtained monomer and the proton numbering for ¹H-NMR assignment are shown below.

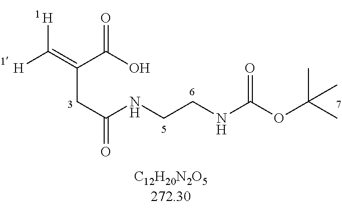 [SMILES: C=C(CC(=O)NCCNC(=O)OC(C)(C)C)C(=O)O]

Yield: 2.8 g; 10.3 mmol; 58%

MS (ESI, 4-5 kV): m/z={[M+Na]}=295.13

¹H NMR (250 MHz, dmso-d₆): δ=12.46 (br. s, OH), 7.87 (br. s., NH), 6.77 (br. s., NH), 6.11 (s, 1H), 5.66 (s, 1′H), 3.08 (s, 3-H), 3.05-2.95 (m, 5-H, 6-H), 1.39 (s, 7-(CH₃)3, 9H).

¹³C NMR (63 MHz, methanol-d₄): δ=172.41 (s, C═O), 168.61 (s, C═O), 157.53 (s, C═O), 135.66 (s, C═C), 128.14 (s, C═C), 79.16 (s, C—(CH₃)₃), 39.82 (s, CH₂), 39.67 (s, CH₂), 39.18 (s, CH₂), 29.75 (s, C—(CH₃)₃).

1.-19. (canceled)

20. Antimicrobial and antifouling polymer comprising a molecular weight of more than 5,000 g mol⁻¹ and as a repeat unit a structure according to formula (I): 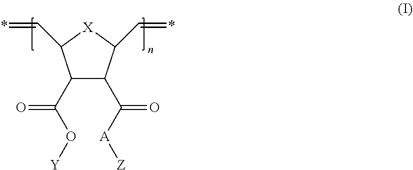
wherein
X is O;
Y is selected from hydrogen or is a negative charge;
A is O;
Z is (CH₂)_{q}N⁺(R₃R₄R₅), wherein:
R₃, R₄, R₅ are independently from each other selected from either H or an C₁-C₆-alkyl;
q is an integer selected from a range of 1 or 3 to 10;
or Z is (CH₂)_{q}N(R¹¹R¹²), wherein:
R¹¹, R¹² are independently from each other selected from either H or an C₁-C₆-alkyl;
q is an integer selected from a range of 1 or 3 to 10; and
n is an integer selected from a range of 10 to 2500.

21. Antimicrobial and antifouling polymer comprising a molecular weight of more than 5,000 g mol⁻¹ and as a repeat unit a structure according to formula (I): 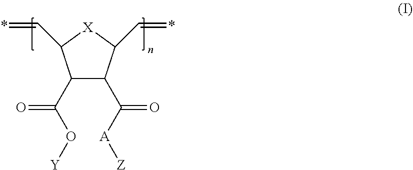
wherein
X is O;
Y is selected from hydrogen or is a negative charge;
A is NH;
Z is (CH₂)_{q}N⁺(R₃R₄R₅), wherein:
R₃, R₄, R₅ are independently from each other selected from either H or ethyl-, propyl-, or isopropyl-;
q is an integer selected from a range of 1 to 10;
or Z is (CH₂)_{q}N(R¹¹R¹²), wherein:
R¹¹, R¹² are independently from each other selected from either H or ethyl-, propyl-, or isopropyl-;
q is an integer selected from a range of 1 to 10; and
n is an integer selected from a range of 10 to 2500.

22. Antimicrobial and antifouling polymer comprising a molecular weight of more than 5,000 g mol⁻¹ and as a repeat unit a structure according to formula (I): 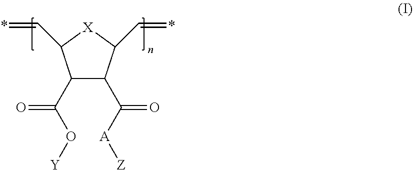
X is CR₁R₂, wherein:
R₁ and R₂ are independently from each other selected from linear or branched C₁-C₆ alkyl,
Y is selected from hydrogen or is a negative charge;
A is NH;
Z is (CH₂)_{q}N⁺(R₃R₄R₅), wherein:
R₃, R₄, R₅ are independently from each other selected from either H or an C₁-C₆-alkyl;
q is an integer selected from a range of 1 to 10;
or Z is (CH₂)_{q}N(R¹¹R¹²), wherein:
R¹¹, R¹² are independently from each other selected from either H or an C₁-C₆-alkyl;
q is an integer selected from a range of 1 to 10; and
n is an integer selected from a range of 10 to 2500.

23. Antimicrobial and antifouling polymer according to claim 22, wherein the repeat unit with a structure according to formula (I) is selected from any of formulae (Ib) or (Ie): 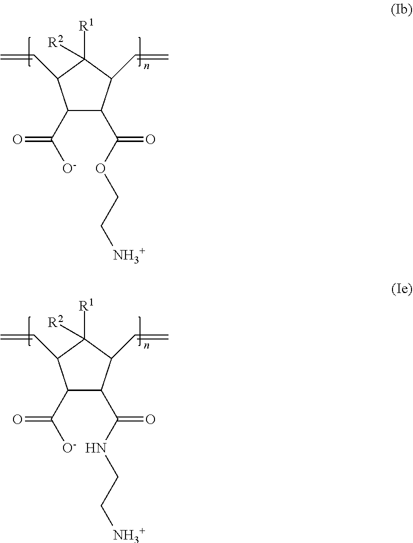
wherein:
R₁ and R₂ are independently from each other selected from linear or branched C₁-C₆ alkyl,

24. Antimicrobial and antifouling polymer comprising a molecular weight of more than 5,000 g mol⁻¹ and as a repeat unit a structure according to formula (I): 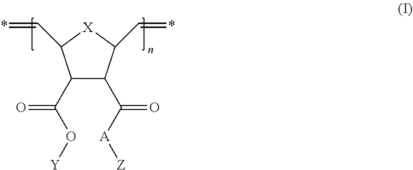
wherein
X is CCR₁R₂, wherein:
R₁ and R₂ are independently from each other selected from hydrogen (H), linear or branched C₁-C₆ alkyl,
Y is selected from hydrogen or is a negative charge;
A is NH or O;
Z is (CH₂)_{q}N⁺(R₃R₄R₅), wherein:
R₃, R₄, R₅ are independently from each other selected from either H or an C₁-C₆-alkyl;
q is an integer selected from a range of 1 to 10;
or Z is (CH₂)_{q}N(R¹¹R¹²), wherein:
R¹¹, R¹² are independently from each other selected from either H or an C₁-C₆-alkyl;
q is an integer selected from a range of 1 to 10; and
n is an integer selected from a range of 10 to 2500.

25. Antimicrobial and antifouling polymer according to claim 24, wherein the repeat unit with a structure according to formula (I) is selected from any of formulae (Ic) or (If):

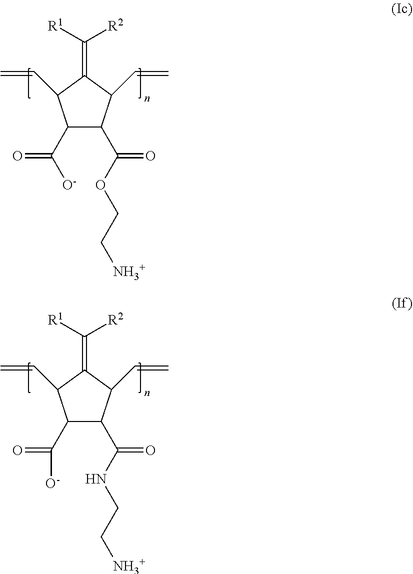

26. Antimicrobial and antibiofouling polymer according to claim 20, wherein the polymer comprises a molecular weight Mₙ of between 5,000 g mol⁻¹ and 1,000,000 g mol⁻¹, preferably between 10,000 g mol⁻¹ and 500,000 g mol⁻¹, more preferably between 20,000 g mol⁻¹ and 500,000 g mol⁻¹, and even more preferably between 20,000 g mol⁻¹ and 200,000 g mol⁻¹, between 20,000 g mol⁻¹ and 150,000 g mol⁻¹, or between 20,000 g mol⁻¹ and 100,000 g mol⁻¹, most preferably between 20,000 g mol⁻¹ and 95,000 g mol⁻¹.

27. Antimicrobial and antibiofouling polymer according to claim 20, wherein 0.05% to 10 wt % of the Z groups of the antimicrobial and antibiofouling polymer of formula (I) are replaced by a crosslinking unit.

28. Polymeric network comprising an antimicrobial and antifouling polymer according to claim 20 and a crosslinker, wherein the polymer network is formed by crosslinking the antimicrobial and antifouling polymers with a crosslinker.

29. Polymeric network according to claim 28, wherein the crosslinker comprises a photo-crosslinking unit or a thermo-crosslinking unit.

30. Substrate comprising an antimicrobial and antifouling polymer according to claim 20, wherein the antimicrobial or antibiofouling polymer is attached covalently or non-covalently onto said substrate.

31. Substrate according to claim 30, wherein the surface attachment occurs via a molecule for surface attachment comprising a photo-crosslinking unit or a thermo-crosslinking unit.

32. Substrate according to claim 30, wherein the polymeric layer formed on the substrate by the antimicrobial or antifouling polymers has a thickness of about 10 nm to about 1000 μm.

33. Use of an antimicrobial and antifouling polymer according to claim 20 for preventing microbial growth and biofouling on a substrate, device or tool.

34. Use according to claim 33, wherein the surface of the substrate is an organic or an inorganic surface.

35. Use according to claim 34 wherein the inorganic surface is selected from the group consisting of surfaces comprising metals or alloys, silicon surfaces, or ceramic surfaces.

36. Use according to claim 34, wherein the organic surface is selected from polymeric surfaces including oxidized poly(styrene), oxidized poly(ethylene), (substituted) poly(ethyleneimine) (PEI), (substituted) poly(vinylpyridine) (PVP), (substituted) PVP-based polymers and co-polymers, poly(diallyldimethylammonium)-based, (substituted) poly(butylmethacrylate-co-amino-ethyl methyl-acrylate), (substituted) poly(2-(dimethyl-amino)-ethyl methacrylate)-based surfaces, co-polymers thereof, fluorinated polymers or co-polymers thereof, silicone polymers or co-polymers thereof, or any further polymer suitable for such an approach.

37. Use according to claim 33, wherein the substrate is selected from the group consisting of an implant, a prosthesis, a joint, a bone, a tooth, screws, anchors, fastener or fixing material, a medical or surgical device or tool, implant trephine or trepan drill, scalpels, forceps, scissors, screws, fasteners and/or fixing material used for implantation, holders, clips, clamps, needles, linings, tubes, water tubes, pipes, water pipes, bottles and bottle inlays, breathing hoses, inlays for medical equipment, surfaces of operating tables, treatment chairs, catheter, stents, any wound dressing material, including plaster, gazes, bandages, bed sheets for clinical or medical purposes, sheets for covering medical devices, book covers, keyboards, computer keyboards, computer, laptops, screens, displays, display covers, lamps, grips of tools and instruments, a biomaterial suitable for tissue support, a tissue carrier system for wound dressing or for volume preservation of solid body tissues, substrates used for storage of cells, tissues, or organs, substrates used for storage of food, refrigerators, coolers, and storage boxes.

38. Antimicrobial and antifouling polymer according to claim 20 for use in treating or preventing microbial infections in a patient.
